(19) United States
(12) Patent Application Publication
(10) Pub. No.: US 2017/0231186 A1
(43) Pub. Date: Aug. 17, 2017

(54) AUTOMATIC ANIMAL PROCESSING DEVICE

(71) Applicant: Milkomax Solutions Laitieres Inc., Sainte-Monique (CA)

(72) Inventors: Victor ROUSSEAU, Nicolet (CA); Marc-Andre JETTE, St-Appolinaire (CA); Françis LECLAIR, Bécancour (CA)

(21) Appl. No.: 15/504,465

(22) PCT Filed: Jul. 10, 2015
(86) PCT No.: PCT/CA2015/050645

§ 371 Date: Feb. 16, 2017

Related U.S. Application Data
(60) Provisional application No. 62/038,749, filed on Aug. 18, 2014.

(30) Foreign Application Priority Data
Oct. 3, 2014 (CA) PCT/CA2014/050951

(51) Int. Cl. A01J 5/003; A01K 1/06; A01J 5/017; A01J 7/02; A01J 7/04; A01K 13/00; A01K 1/01

(52) U.S. Cl. CPC A01J 5/003; A01K 13/004; A01K 1/0613; A01K 1/0132; A01J 7/02; A01J 7/025; A01J 7/04; A01J 5/0175

(57) ABSTRACT

An automatic animal processing device for automatically retrieving a domestic animal partly from a stall to process the animal while restraining the animal. The animal processing device includes an animal controlling mechanism operative to engage, position and restrain the animal for processing. The animal controlling mechanism may include at least on articulated arm to constrain and immobilize an animal to process it, e.g. milk it. The animal processing device may be a milking machine may be a milking machine having a milking head assembly and a cleaning system therefor whereby the milking head assembly is cleaned inside a compartment. The animal processing device may be a dual animal milking machine having full and half operation modes whereby two sets of processing equipments are used to service two animals simultaneously or only one set is used for both respectively.

### CROSS-REFERENCE TO RELATED APPLICATION

This application claims priority from U.S. Provisional Application Ser. No. 62/038,749 filed Aug. 18, 2014, and from PCT International Application No. PCT/CA2014/050951, both of which are hereby incorporated herein by reference.

### TECHNICAL FIELD

The present invention relates to an automatic animal processing device for controlling and restraining a domestic animal at least partly to process the animal to perform a task upon it. In a particular, non-limiting example, the domestic animal is a cow.

### BACKGROUND

The raising of domestic animals, particularly cows, is a very demanding task. In the case of cows, they must be attended to on a daily basis for milking, cleaning and feeding. The milking is usually done several times a day. As such, a dairy farm with 100 or more cows is a very labour-intensive business. Usually, such dairy farms are operated and run by a family. Since the cows have to be attended to on a daily basis, along with the many other chores associated with such a farm, and because the herd of cows cannot be left unattended for long periods of time, the leisure activities of the family are quite restrained.

Modern milking machinery has been developed to facilitate the milking of cows, the feeding and the cleaning of stalls. U.S. Pat. No. 6,349,028 discloses an example of an automatic milking machine, in which a robotic arm is used for attaching a teat-cup to an animal's teat. However, physical labour is still required to herd the cows one-by-one into the apparatus and to precisely position each cow for the automatic milking. Although the milking is done automatically, such operation can be more labour-intensive in that the cows must be removed from their stalls, brought to the milking machine and then returned to the stalls afterwards.

In order to alleviate the problem of shuttling the cows from their stalls to the milking apparatus, milking parlors have been developed, as described for example in U.S. Pat. No. 6,814,026 and U.S. Pat. No. 7,086,348. Typically, a milking parlor includes a shuttle stall which loads an animal thereon, backs it up to a milking station, advances the cow out of the milking station and releases it in a release area, at which point the cow needs to be either brought back to its stall and repositioned therein or released outdoors to pasture. This is again labour intensive, since the cows must be herded or removed from their stalls, manually positioned and secured on the shuttle stall, and then returned to their stalls after the milking process is complete. Furthermore, the stall arrangements often create traffic jams, since the cows must be displaced in front of shuttle stalls which are occupied during the milking process.

U.S. Pat. No. 8,651,050 describes an automatic animal retrieving platform that has a confining means in the form of a cage with an opening and a separate extendible retrieving means. The platform assembly includes a displaceable floor that extends to the rear of the stall and retrieving arms that grasp the animal and cause it to back up slowly onto the platform and therefore into the cage via the opening, where the animal is confined in the cage of the platform assembly. Once the animal is confined in the cage, the platform assembly is able to effect a job function with the animal, such as for example the milking of a cow. Such an automatic animal processing device can significantly reduce the job functions of the operators of a milking farm, since human labour is not required to remove cows from their private stalls, herd them to a milking parlor and then return them to their stalls. However, this machine is a bulky and heavy machine, that can be difficult to impossible to use and to maneuver in smaller spaces or spaces with a low ceiling. This machine also has very limited ability to adjust its operation and components (e.g. retrieving arms) for animals above a certain height and is not capable of dealing with animals above a certain height. Furthermore, it is difficult to maintain the necessary cleanliness of the machine and all of its various parts in order to avoid contamination, as required to meet hygienic standards in the milking industry for example. Finally, being able to milk only one cow at a time, the machine is limited in terms of the number of cows it can process.

There thus exists a need in the industry for improvements that provide increased flexibility and adaptability.

### SUMMARY

The present invention is directed, in some embodiments, to an animal processing device for automatically immobilizing and constraining a domestic animal, such as a cow, at least partly to process the animal to perform a process, such as automatic milking.

In accordance with a fist broad aspect, is provided an animal milking machine for automatically milking a domestic animal that is in a stall. The animal milking machine comprises a vehicular body displaceable in a stall environment to the rear opening of the stall, the vehicular body having a base. The animal milking machine further comprises at least one articulated arm connected to the vehicular body comprising a first link member and a second link member meeting together at an articulation, each of the at least one articulated arm having: a stowed configuration, wherein the articulation is closed and the first and second link members are tucked together towards the vehicular body to allow unimpeded displacement of the vehicular body; and a working configuration wherein the articulation is partially open such that the first and second link members form a V shape for flanking a captive domestic animal and immobilizing at least a rear portion the domestic animal in the lateral direction. The animal milking machine further comprises a milking head connected to the vehicular body automatically displaceable to engage the domestic animal when immobilized and to milk the domestic animal.

In accordance with a second broad aspect, is provided an animal milking machine for automatically processing a domestic animal in a stall. The animal milking machine comprises a vehicular body displaceable to approach the domestic animal to perform a milking operation on the domestic animal. The animal milking machine further comprises a deployable milking head connected to the vehicular body automatically displaceable between a working configuration wherein the milking head is extended away from the vehicular body to engage the domestic animal to milk the domestic animal and a stowed configuration wherein the milking head is retracted toward the vehicular body. The animal milking machine further comprises a cleaning compartment in the vehicular body defining a chamber dimensioned to receive the milking head when in the stowed configuration and a cleaning fluid delivery system for performing a cleaning operation upon the milking head in the chamber in the vehicular body.

In accordance with a third broad aspect is provided a dual animal milking machine for automatically milking two domestic animals in respective stalls, the dual animal milking device comprising a pair of animal operation equipment each comprising an animal controlling mechanisms for immobilizing a respective one of the two domestic animals to perform a milking operation; and a milking head deployable to milk the respective one of the two domestic animals when immobilized by the animal controlling mechanism. The dual animal milking machine further comprises a vehicular body displaceable in a stall environment to simultaneously align the pair of animal operation equipment with respective rear openings of respective stalls. The dual animal milking machine further comprises a controller in communication with the pair of animal controlling mechanisms and the pair of milking heads for controlling the operations thereof. The dual animal milking machine has two operational modes: a full operation mode, whereby each of the animal operation equipments function simultaneously to perform simultaneous milking operations; and a half operation mode, whereby one of the animal operation equipments services each of the two domestic animals to perform a milking operation on each of them in sequence.

### BRIEF DESCRIPTION OF THE DRAWINGS

The invention will be better understood by way of the following detailed description of embodiments of the invention with reference to the appended drawings, in which:

FIG. 1 is a perspective view of an automatic animal processing device, in accordance with a non-limiting example of implementation with automatically displaceable arms in a stowed configuration and a service door opened;

FIG. 2 is a perspective view of the automatic animal processing device of FIG. 1, with automatically displaceable arms in a working configuration;

FIG. 3 is a perspective view of the automatic animal processing device of FIG. 1, with a stall cleaning mechanism deployed;

FIG. 4 is a side elevation view of the automatic animal processing device of FIG. 1, during a milking operation;

FIG. 5 is a top view of the automatic animal processing device of FIG. 1, during a milking operation;

FIGS. 6-7 illustrates an example of a robotic milking machine that can be supported by the animal processing device of FIG. 1, mounted inside a housing;

FIG. 8 is a perspective view of an elevator mechanism of the animal processing device, in accordance with a non-limiting example of implementation;

FIGS. 9 and 10 provide a partial cutaway perspective view of a motorized arm fixture of an animal controlling mechanism of the animal processing device, in accordance with a non-limiting example of implementation;

FIG. 11 illustrates a brush assembly of the animal processing device, in accordance with a non-limiting example of implementation;

FIG. 12 is a front perspective view of a milking head cleaning system in accordance with a non-limiting example of implementation;

FIG. 13 is a front elevation view of the milking head cleaning system of FIG. 12; and

FIG. 14 is a rear perspective view of the milking head cleaning system of FIG. 12.

### DETAILED DESCRIPTION

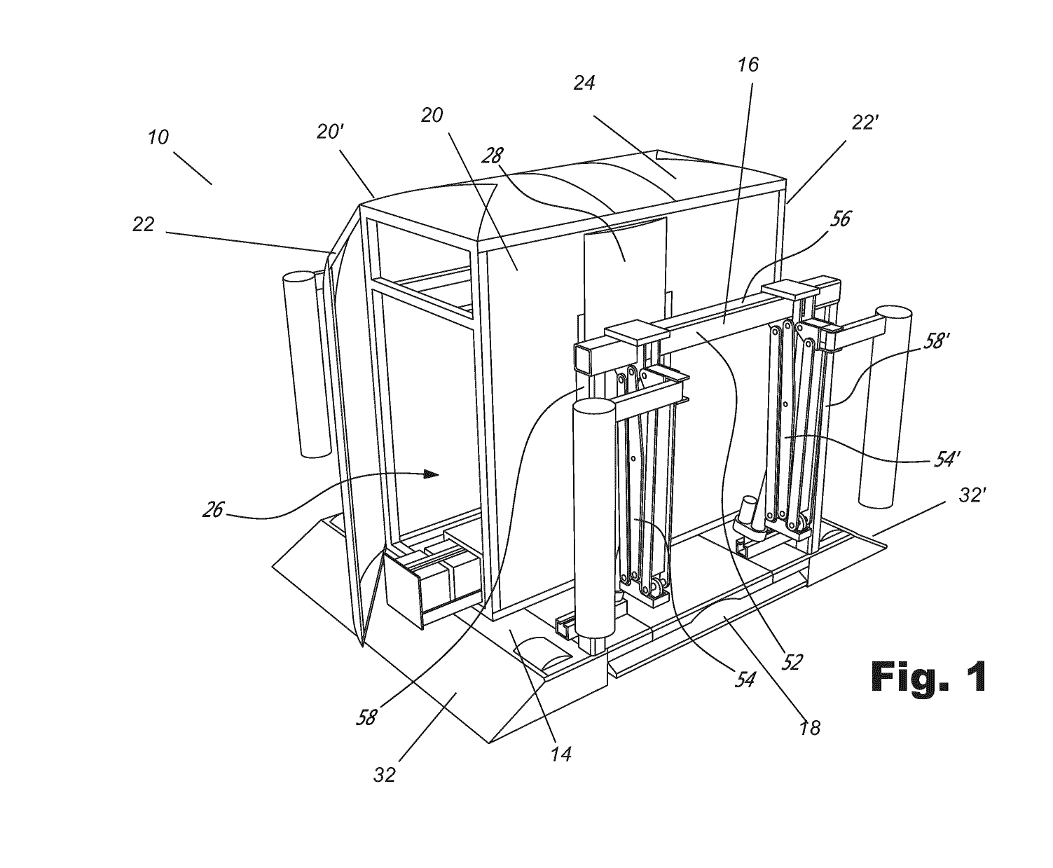

FIG. 1 illustrates an animal processing device 10, in accordance with an embodiment. The animal processing device 10 is designed to partly capture and control a domestic animal, such as a cow, in a stall in order to process it by, for example, milking the animal without human intervention.

Advantageously, the improved animal processing device is characterized by improved flexibility and adaptability, as compared to prior art designs. The novel animal processing device is also designed to be adjustable to accommodate for different sizes and heights of domestic animals, adding to its improved flexibility. Furthermore, the novel animal processing device incorporates a cleaning system that improves both the internal and external cleanliness of the machine, of great importance in any industry with strict and high hygienic standards (e.g. dairy farming).

In yet another advantage, the improved animal processing device is designed to provide for much simpler access to the various components of the machine, as compared to prior art designs. More specifically, the animal processing device is rotatable and can be raised and lowered, which manoeuvrability allows an operator to easily access the various components of the machine, such that for example these components can be quickly repaired and/or replaced in cases of faulty operation or regular wear and tear.

In yet further advantages, the improved animal processing device has a lightweight design and requires less space real-estate to perform its function. Advantageously, domestic animals can be processed in their stall. This fact, along with the lightweight, small-space design contribute to yet a further advantage, which is that in some embodiments, the animal processing device can be configured to process two domestic animals, e.g. simultaneously. In yet a further advantage, the animal processing device, configured to process two domestic animals, may provide a redundant system whereby in case of failure in some part of the device would otherwise render the device inoperable to process a domestic animal, the remainder of the device which serves to process another domestic animal simultaneously can be used to process the first domestic animal in turn. For example, the device may be adapted to milk two cows at the same times; but should a part of the device break, e.g. one of two milking heads used in simultaneous cow milking, the device may still be used to milk both cows, using the still-functioning components (e.g. milking head) on both cows in sequence. This redundancy can be a useful fail-safe, for example in dairy operations where failure to milk the cow can be harmful to the cow and to future milking efficacy.

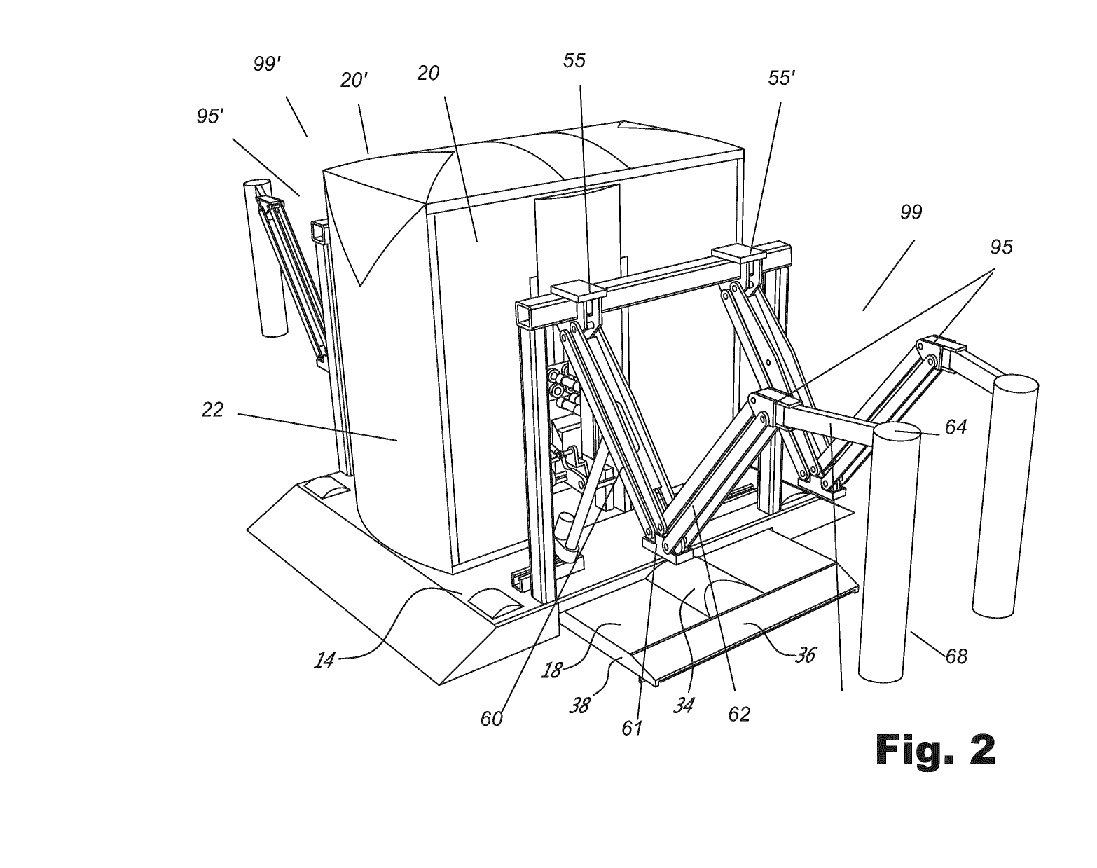

Referring now to the non-limiting example of implementation shown in FIGS. 1 and 2, the animal processing device 10 includes a vehicular body 11, comprising a base 14, a housing 12, a controller unit (not shown), an animal controlling mechanism 16 and, in this example, a displaceable bridge 18.

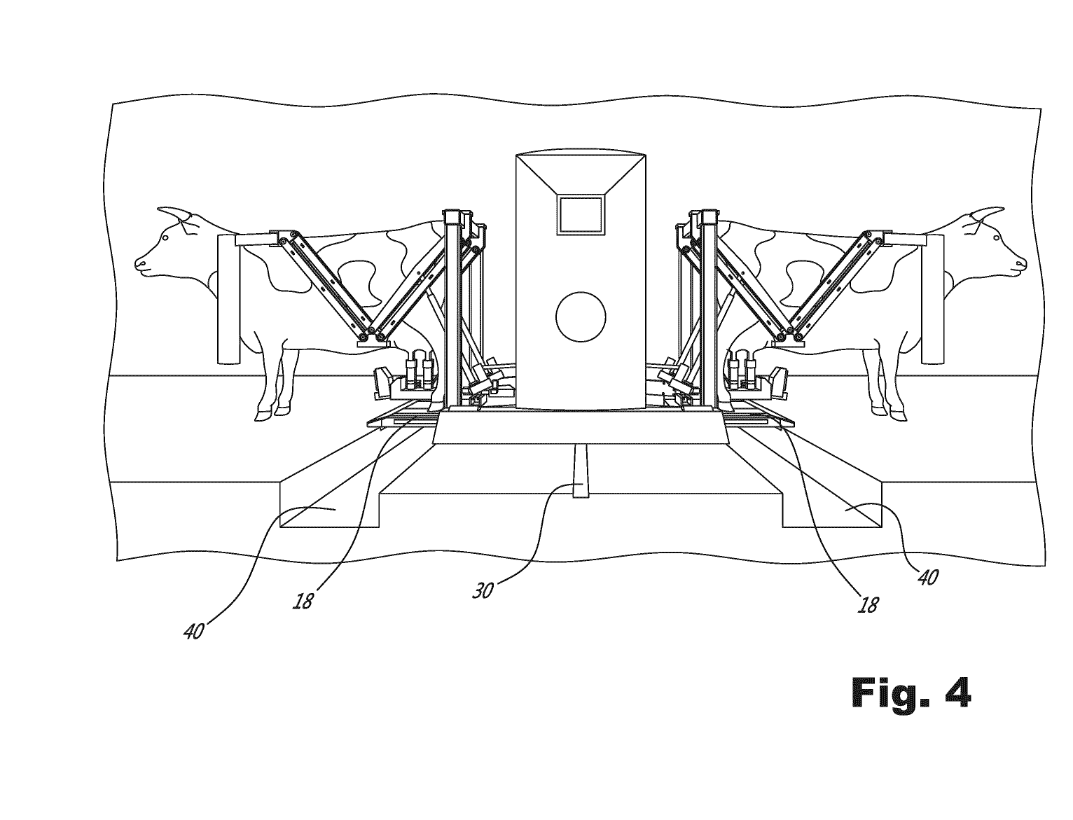

With reference to FIG. 4, the animal processing device 10 is designed to be displaced along a single track 30 (defined in or installed on the floor of a building, for example along the centre of an aisle or corridor of animal stalls) by locomotion mechanism comprising a motorized propulsion system. In this example, the motorize propulsion system includes an electric motor, which drives support wheels (not shown) mounted on an undercarriage of the base 14. In this example, the animal processing device 10 is supported on its wheels and the track 30 serves as a guide rail for guiding the animal processing device in locomotion along the right path. Although shown here in simplified form, the track 30 may have a T-shaped cross section and may be received in the base of the vehicular body in a corresponding T-shaped slot. On one embodiment, the track 30 is comprised to I-shaped beams which are installed by securing the bottom of the I-shaped beams into the floor of a location such as a barn, using any appropriate attachment means such as screws, and the bas 14 has a T-shaped slot for receiving at least the top part of the I-shaped beams. Note however that other forms of displaceable guide means are contemplated, such as a motorized wheel platform guided by a wire and/or electronic sensors to displace and locate the animal processing device 10 at precise locations. Accordingly, the animal processing device 10 is displaceable along track 30 to various locations automatically by a computer-controlled controller unit associated with location sensors and other sensors. The functionality of such sensors will not be described in further detail herein, since it is well known to those skilled in the art. The controller unit is programmable to position the animal processing device 10 at any predetermined position along the track 30. In alternate embodiments, the vehicular body may be displaceable by other means such as by transporting on a conveyor belt or being pulled on a cable (along a track or otherwise) by a remote mechanism.

In a specific, non-limiting example of implementation, the animal processing device 10 is characterized by a maximum height of 7 feet and a maximum length of 10 feet. This size beneficially makes the device suitable for displacement in many tie-stall barns where an example of the device may be used as an automatic cow milking machine. The animal processing device 10 may also be characterized by a width that is at most 2 feet larger than a central aisle or corridor along which the device 10 is to be displaced.

The controller unit (not shown), may be mounted and secured inside the housing 12, and be operative to control the displacement of the animal processing device 10 along the track 30, as well as various other operations of the animal processing device 10, as will be described below. This controller unit may wirelessly communicate with and/or be controlled by a remote computing unit, such as a server, a personal computer, a laptop, a tablet, a PDA, a smartphone, etc. In a specific, non-limiting example of implementation, the controller unit is a microprocessor-based electronic control unit, formed of hardware and/or software and/or firmware modules, that interconnects and controls the various components of the animal processing device 10.

For purposes of the following description, it will be assumed that the controller unit is mounted and contained inside of the housing 12. Note however that different configurations are possible, in which the controller unit is alternatively mounted on the housing 12 without being contained inside of the housing 12, for example mounted at least in part on an external surface of the housing 12. In yet another alternative configuration, the controller unit may be remotely located with respect to the housing 12.

The housing 12 is constructed at least in part of a metal material, such as aluminium, or other suitable material and defines opposed side walls 20, 20′, opposed end walls 22, 22′ and a roof 24. A frame formed of a plurality of interconnected frame members (shown in part in FIGS. 1 and 2) supports the side walls 20, 20′, end walls 22, 22′ and roof 24 in the predefined configuration of the housing 12. The side walls 20, 20′ and end walls 22, 22′ are secured to the base 14, for example through welding, gluing or mechanical attachment means, among other possibilities. Together, the side walls 20, 20′, end walls 22, 22′, roof 24 and base 14 define a substantially enclosed space 26 (see FIG. 1) within which the controller unit may be securely contained, protected from external elements.

In the example shown in FIG. 1, the enclosed space 26 defined by the housing 12 is rectangular in shape, designed and sized to accommodate the machinery stored therein. Note however that this enclosed space may be characterized by different shapes and dimensions.

Note that materials other than metal may also be used in the construction of the housing 12, including for example plastic and canvas. Furthermore, the walls and roof of the housing 12 are not necessarily rigid in construction, but may also be flexible (e.g. bendable aluminium, wire-mesh or canvas), at least in part (e.g. a portion of a wall of the housing 12 may be formed of wire-mesh).

Each of the side walls 20, 20′, end walls 22, 22′ and roof 24 of the housing 12 may consist of a unitary body of material or, alternatively, of two or more inter-connected bodies of material, which may be formed of the same or different materials.

Accordingly, though the housing 12 defines an enclosed space 26 that allows to protect components stored and/or mounted therein from external elements (e.g. dust, dirt, animal waste, etc.), this space 26 is not necessarily hermetic when closed, depending on the choice and design of the materials used to construct the walls and roof of the housing 12.

Optionally, additional processing equipment (e.g. components, machinery, control systems, etc.) may also be installed within the housing 12, including for example one or more back-up batteries (e.g. 12 Volt battery pack), one or more pumps, one or more motors, as well as one or more machines to process an animal, such as a robotic milking machine for milking cows, as will be discussed in further detail below. Specific examples of components or machinery that may be installed within the housing 12 include pipes and/or hoses (e.g. for water, air, milk, etc.), reservoirs (e.g. for milk), milk treatment systems, valves, a vacuum pump, a water pressure pump, a centrifugal pump, a metering pump, an air motor, electronic components and safety and/or security mechanisms, among many other possibilities.

At least one of the end walls 22, 22′ of the housing 12 defines an access means (e.g. a door) for accessing the interior of the housing 12, this access means being manually or automatically movable between an open and a closed position. In the example shown in FIG. 1, each end wall 22, 22′ is itself a door, attached by hinges to a respective frame member of the housing 12 such that it can swing either to the open position to provide access to space 26 or to the closed position to enclose the space 26. Note however that an end wall 22, 22′ of the housing 12 may define a door that is smaller than the total area of the respective end wall 22, 22′, in which case the door consists of a panel within the end wall 22, 22′ that can slide or swing open to provide access to the space 26.

When a door of one of the end walls 22, 22′ is in the open position (see FIG. 1), it is possible for an individual to reach or step inside the space 26 of the housing 12, for example to perform a maintenance or cleaning operation therein. However, when the animal processing device 10 is in operation, the doors of the end walls 22, 22′ are closed to protect the controller unit and any other machinery within the housing 12 from external elements (e.g. dust, dirt particles, animal deposits, etc).

Each side wall 20, 20′ may also include an access means, such as a panel 28 (or any other suitable type of door or section), at least a portion of which is automatically movable between respective open and closed positions (e.g. that controllably slides or swings) to provide access to the interior of the housing 12. In a specific, non-limiting example of implementation, a portion of the panel 28 slides open to allow access to and operation of specific machinery contained inside the housing 12. As shown in FIGS. 2-7, this specific machinery may be a robotic milking arm, which upon opening of the portion of the panel 28, can automatically extend out of the housing 12 to milk a cow and automatically retract back inside of the housing 12 once the processing has finished, as will be discussed in further detail below.

The base 14 is designed to support the housing 12 and the animal controlling mechanism 16, as well as any machinery mounted inside of the housing 12. The base 14 also supports the displaceable bridge 18, as will be discussed below. The base 14 includes an undercarriage to which are mounted the support wheels that drive the animal processing device 10 along the ground or floor of a building, as well as engaging means provided on its underside for engaging the track 30 to direct movement of the animal processing device 10. Examples of possible engaging means for engaging the track 30 may include a rigid projection, a roller and a spring-loaded wheel, among other possibilities. The base 14 may also support brushes mounted to its undercarriage or underside for cleaning the track 30 during displacement of the animal processing device 10, which can contribute significantly to reducing and/or avoiding contamination as well as avoiding dirt and detritus buildup and ensuing blockage. In a specific, non-limiting example, motorized brushes (controlled by the controller unit of the animal processing device 10) are mounted around each support wheel, where these brushes rotate and clean the wheels, as well as the track 30, during displacement of the animal processing device 10.

As shown in the non-limiting example of implementation illustrated, the base 14 is rectangular in shape, with optional downwardly angled edges 32, 32′ at either end. Advantageously, these angled edges 32, 32′ allow the base 14 to scrape and sweep the ground or floor of the building as the animal processing device 10 moves along its track 30. Note that the base 14 may be characterized by different shapes and dimensions.

The displaceable bridge 18, which is motorized and controlled by the controller unit of the animal processing device 10, serves to provide a landing or platform that can receive the rear end of an animal when the animal is manoeuvred by the animal processing device 10, controlling the animal such that the animal processing device 10 can safely process the animal. With reference to FIGS. 1, 2 and 4, the displaceable bridge 18 is movable between a retracted position, in which it is stored inside the base 14, and an extended position, in which the bridge 18 projects from the base 14 over a gutter 40 located behind the stall where an animal is located. In the extended position, the front, downwardly angled edge 36 of the bridge 18 rests on the edge of the stall, which advantageously affords stability to the animal processing device 10, reducing the chances that movement by the animal could rock or tip the machine.

Note that the movement of the displaceable bridge 18 during both extension and retraction may be a non-linear movement, whereby this movement of the bridge 18 can adapt or adjust to irregularities in height of the stall floors.

The displaceable bridge 18 is shown in the example of implementation illustrated in FIGS. 1, 2 and 4 as being rectangular in shape; however, this bridge 18 may be characterized by different shapes and sizes.

In a specific, non-limiting example, the bridge 18 is positioned underneath an upper floor panel of the base 14, mounted with engaging means (e.g. slides, slide rails, linear supports, rollers) provided on either side of the bridge 18 to engage and mate with respective tracks or rails mounted on (or defined in) the base 14. The bridge 18 is extended from its retracted position, and retracted from its extended position, by a bridge actuating mechanism controlled by the controller unit and mounted on the underside of the base 14. During extension of the bridge 18, a sensor or other detecting means provided either on the bridge 18 or the base 14 instructs the controller unit when to stop the actuating mechanism. Should there be an obstruction, such as a leg of the animal placed between the front edge 36 of the displaceable bridge 18 and the gutter 40, the bridge drive will stop automatically. Examples of a bridge actuating mechanism include a motorized cylinder and a motorized rack-and-pinion, among other possibilities.

Note that various other suitable mechanisms for mounting the bridge 18 to the base 14, as well as for actuating the extension and retracting of the bridge 18, can be contemplated.

As shown in FIG. 2, the bridge 18 includes a central, rounded protuberance 34 (e.g. a hump or dome-shaped portion) with a downwardly slanted front edge, this protuberance located on the upper surface of the bridge 18. Advantageously, the central protuberance 34 ensures that, as an animal is backed up onto the extended bridge 18, the rear feet of the animal straddle the protuberance 34, thereby centering the rear end of the animal on the bridge 18 and properly positioning the animal with its rear legs spread for the processing to be effected by the animal processing device 10. The slanted front edge of the protuberance 34 provides a gradual and safe incline onto which the animal may step if not positioned properly when backing onto the bridge 18, while the rounded protuberance 34 will encourage a foot of the animal to slide off of the protuberance 34 and onto the flat upper surface of the bridge 18, thus guiding the animal into the proper position with its rear legs spread.

Note that, on either side of the protuberance 34, the upper surface of the bridge 18 may be covered with a rubber matting to provide good footing for the animal.

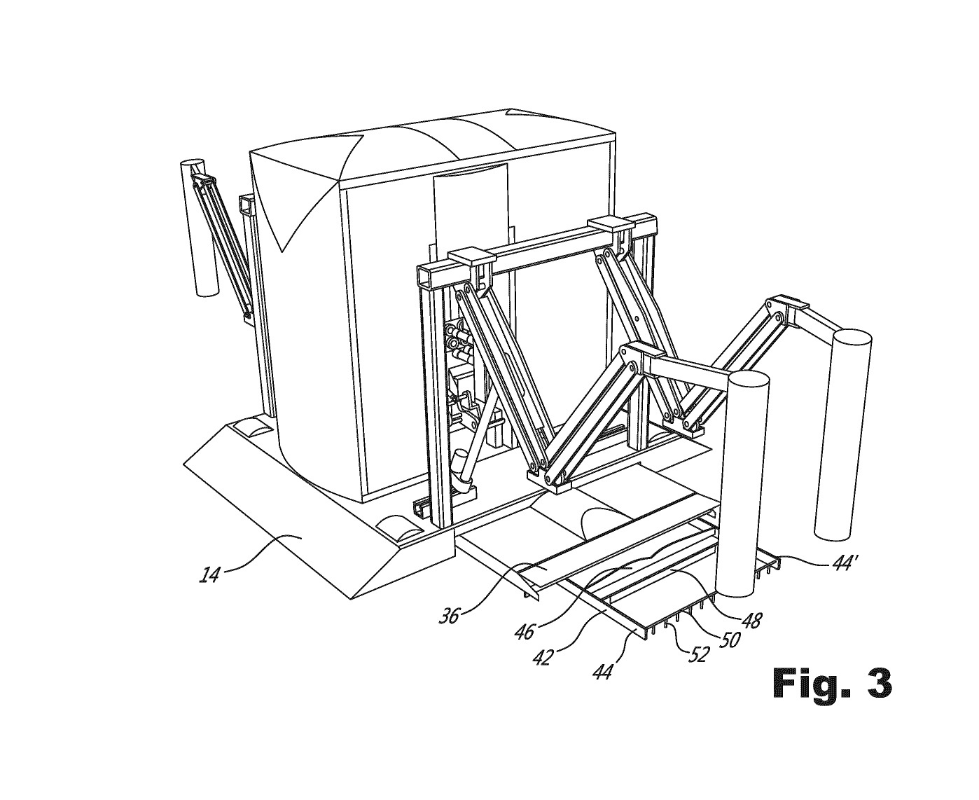

In a specific, non-limiting example of implementation, the front, downwardly angled edge 36 of the bridge 18 is implemented by a plate that is rotatably attached to the body of the bridge 18 (e.g. a hinged plate, a pivotal plate or a telescopic plate) and the bridge 18 optionally supports a stall cleaning mechanism 42 that is movable between a retracted position and an extended position, as seen in FIG. 3.

The stall cleaning mechanism 42, which is also motorized and controlled by the controller unit of the animal processing device 10, is operative to clean at least a portion of the floor of the stall when the animal's rear end is positioned on the bridge 18, possibly simultaneously with the animal processing device 10 processing that animal. The stall cleaning mechanism 42 is movable between a retracted position, in which it is stored inside the bridge 18, and an extended position, in which the stall cleaning mechanism 42 projects from the bridge 18 into the stall. As the stall cleaning mechanism 42 extends out from the bridge 18, the front edge 36 of the bridge 18 pivots upwardly to allow the stall cleaning mechanism to move into the stall. As the stall cleaning mechanism 42 retracts back into the bridge 18, the front edge 36 pivots downwardly to close the front of the bridge 18 and cover the stall cleaning mechanism 42.

In the specific, non-limiting example of implementation shown in FIG. 3, the stall cleaning mechanism 42 is formed of a pair of arms 44, 44′ interconnected by a brace 46. Pivotably mounted between the arms 44, 44′ is a scraper plate 48 and a rake plate 50, the latter defining a plurality of projecting prongs 52. During extension of the stall cleaning mechanism 42 into the stall, the scraper plate 48 and rake plate 50 are flipped upwardly, such that they don't make contact with the stall floor. Once the stall cleaning mechanism 42 is fully extended into the stall, the scraper plate 48 and rake plate 50 are flipped downwardly, bringing them into contact with the stall floor. During retraction from the stall of the stall cleaning mechanism 42, the scraper plate 48 is operative to scrape the stall floor (thereby cleaning debris, such as dirty hay and animal excrement), while the rake plate 50 is operative to grab and spread new, clean hay (e.g. previously deposited at the front of the stall by a separate machine or by an animal caretaker). As the stall cleaning mechanism 42 is retracted fully into the bridge 18, the scraper plate 48 sweeps excrement, dirty hay and possibly other debris out of the stall and into the gutter 40 under the bridge 18.

Note that the stall cleaning mechanism 42 may be characterized by one or more different cleaning plates, including or other than a scraper plate and/or a rake plate.

In a specific, non-limiting example, the stall cleaning mechanism 42 is positioned underneath the upper surface of the bridge 18, mounted with engaging means (e.g. slides, slide rails, linear supports, rollers) provided on either side of the arms 44, 44′ to engage and mate with respective tracks or rails mounted on (or defined in) the bridge 18. The stall cleaning mechanism 42 is extended from its retracted position, and retracted from its extended position, by any suitable displacement means (e.g. a piston, an actuating cylinder, chains, chain and sprockets, etc.) controlled by the controller unit and mounted on the underside of either the bridge 18 or the base 14.

Note that various other suitable mechanisms for mounting the stall cleaning mechanism 42 to the bridge 18, as well as for actuating the extension and retracting of the stall cleaning mechanism 42, can be contemplated.

Note that the animal processing device 10 may optionally include a bridge cleaning mechanism for cleaning both the bridge 18 and the stall cleaning mechanism 42 during their retraction movement, as will be discussed in further detail below.

The animal controlling mechanism 16 of the animal processing device 10 is also mounted on the base 14 and is electronically controlled by the controller unit. The animal controlling mechanism 16 is operative to position an animal for processing, such as by manoeuvring it into a position from its stall by contacting the body of the animal standing in the stall and applying a gentle, comfortable pressure to the animal for guiding a displacement of the animal, and to restrain the animal in position while the animal processing device 10 processes the animal, such as by performing an animal-related task like milking the animal.

With reference to FIGS. 1-6, the animal controlling mechanism 16 comprises at least one, and in this example two, automatically displaceable arms 54, 54′. The automatically displaceable arms 54, 54′ are connected to the vehicular body 11 and are laterally spaced apart such as to be able to engage the body of an animal from opposed sides thereof. In the example shown, the animal controlling mechanism 16 is supported by a frame 53, in this example formed of a metal beam structure 52. The beam structure 52 includes a horizontal cross-member, which in this example is a top beam 56 mounted on a pair of vertical beams 58, 58′, the latter being fixedly mounted (e.g. welded or attached by mechanical fasteners, etc.) to the upper surface of the base 14. Each automatically displaceable arm 54, 54′ may be supported by the frame 53; in this example, the automatically displaceable arms 54, 54′ are connected to the top beam at respective shoulder joints 55, 55′. The automatically displaceable arms 54, 54′ may be implemented by a, e.g. spring-loaded, foldable arm structure, and are movable between a stowed configuration (shown in FIG. 1) and a working configuration (shown FIG. 2) and are capable to acquire various intermediate extended positions.

The automatically displaceable arms 54, 54′ may be connected to the horizontal cross-member by an adjustable connection. For example, the shoulder joints 55, 55′ may be slidably receive the top beam 56 in a corresponding aperture and are fixed in place by fasteners, e.g. bolts, which can be loosened to allow horizontal displacement of the automatically displaceable arms 54, 54′ along the top beam 56. In this way the spacing of the arms may be manual adjustable. The base of the telescopic cylinders, described in more details below, may also be provided in a track and held in place by fasteners that can be loosened to slide the base of the telescopic cylinders along the track to allow the spacing adjustment. A motorized displacement means may also be provided to move the shoulder joints 55, 55′ and the bases of the telescopic cylinders along their respective top beam/tracks if desired although for the present example it was not provided.

Thus each automatically displaceable arm may have a stowed configuration. In the stowed configuration it is located over the base to allow unimpeded displacement of the vehicular body. In practice, the vehicular body may travel around stalls, e.g. tie-stalls. For example, the vehicular body 11 may be installed on a track 30 that runs down the center aisle of a barn having tie-stalls on both sides where animals (e.g. cows) are tied. The stalls typically have a rear opening facing the center aisle. In this case, the opening is considered a rear opening because a cow (or other domestic animal) occupying the stall is typically facing into the stall and therefore presenting its rear to the aisle at the opening. As the vehicular body 11 may be configured to travel between stall openings, stopping at stall openings to process domestic animals contained therein. As it does, the automatically displaceable arms 54, 54′ are kept out of the way of the stalls (and animals) so as to permit this displacement of the vehicular body 11, by adopting the stowed configuration wherein they are located over the base 14, by which in this example, they are at least partially located over the base, e.g. in a folded configuration as shown in FIG. 1. In one example the entire arms are over the base when in the stowed position however in other examples the arms may be considered over the base even though portions of the arms protrude slightly from the base, for example if the majority of the arms is located over the base or if the center of gravity of the arm is so located. In general the animal controlling mechanism 16 has a stowed configuration in which is located over the base at least in part.

The automatically displaceable arms 54, 54′ also have a working configuration where they extend outwards away from the body. This allows them to immobilize a domestic animal in the stall and constrain the domestic animal, or at least its rear portion. One of the advantages of the animal processing device 10 is that it constrains domestic animals with displaceable arms. In this example, the automatically displaceable arms 54, 54′ are articulated arms that are lightweight and foldable to compact size, particularly compared to cage-type confining devices typically used to confine animals. Yet automatically displaceable arms 54, 54′ are robust and capable of constraining a domestic animal, e.g. a cow, to prevent a movement of the animal. In many cases, such as where the processing equipment is milking equipment and the domestic animal is to be milked, it may be important to constrain the rear portion of the animal where the teats are located to prevent movement, e.g. side-to-side movement of the rear portion of the animal so that milking equipment can be installed and operated on the animal. In the example shown, the rear and the whole sides of the cow are constrained by the automatically displaceable arms 54, 54′ without requiring bulky cages and without overhead members that would limit the size of the animal that can be milked, as a cage does. When the processing is completed, the automatically displaceable arms 54, 54′ can return to the stowed configuration, thus occupying very little space compared to a cage. To this end, in this example, the automatically displaceable arms 54, 54′ are retractable arms that retract towards the vehicular body 11 in the stowed configuration such that they are close to, or in, the vehicular body 11.

In the a working configuration of the present example, the automatically displaceable arms 54, 54′ extend outwards away from the vehicular body along a side of at least the rear of the domestic animal flanking it to immobilize the domestic animal in the lateral direction such that the animal, or at least its rear, cannot move from side-to-side. The automatically displaceable arms 54, 54′ may immobilize the animal in its stall if the animal is kept in its stall during the operation. Unlike a cage-based solution where an animal must back into a cage, the automatically displaceable arms 54, 54′ can be extended into the stall to immobilize the animal in the stall, i.e. entirely or partially in the stall. The automatically displaceable arms 54, 54′, are capable of withstanding around 1500 to 2000 lbs of lateral forces. They may also be provided with flexible tongue mounted upon the end of each arm and directed inwardly towards the animal to guide the animal and train it not to force too hard against the arms.

With reference to FIG. 1 and FIG. 2, in the example shown, the automatically displaceable arms 54, 54′ are articulated arms that will now be describe with reference to automatically displaceable arm 54. In this example both arms are of similar construction. The automatically displaceable arm 54 comprises a first link member 60 and a second link member 62 linked together at an articulation 61. The articulation between the first link member 60 and the second link member 62 of this example is an elbow joint 61 and will be referred as such herein. The first link member 60 is a falling member because when folded it extends downwards towards the elbow joint 61, whereas the second link member 62 is a rising member because it extends upwards from the elbow joint 61. Note that in alternative embodiments, e.g. where the automatically displaceable arms 54, 54′ are connected at a lower point the vehicular body 11, the first link member 60 may be a rising member rising up towards the elbow join 61 and the second link member 62 may be a falling member extending downwards from the elbow joint 61. In such an example the body-engaging portion, discussed in more details below, may be supported from the bottom.

Returning to the example of FIG. 1 the first and second link members 60, 62 of this example are metal links and are referred herein as first and second links 60, 62 respectively. Although the first and second links could be of unitary constructions, in the example shown they each are made of four linked rods each joined at respective ends to the joint of the link. Advantageously, this lightweight design also allows for the two links to fold over each other very compactly in the stowed configuration. The automatically displaceable arms 54, 54′ are connected to the vehicular body 11, in this example at a frame 53, and more specifically to the horizontal top beam 56, via a shoulder joint. The automatically displaceable arms 54, 54′ serve to constrain the domestic animal to process, or at least to constrain the rear thereof, and therefore have a rigidity sufficient to constrain the animal. In the case where the domestic animal is a cow that is to be milked, the automatically displaceable arms 54, 54′ are sufficiently rigid to prevent a movement, in this example side-to-side movement of the cow. In this example, the shoulder joint, first link, elbow joint, and second link together have a rigidity in the lateral direction such that ordinary swaying of a cow is prevented. More particularly, the rear of the animal is constrained. To this end the shoulder joint and first link together are rigid enough (particularly in the lateral direction) to constrain movement of the rear of the animal.

Although the example provided here describes a two-link, fold-over construction for the automatically displaceable arms 54, 54′, any construction having a stowed configuration and a working configuration as described herein may be used if suitable.

The automatically displaceable arms 54, 54′ in this example also immobilize the domesticated animal in the longitudinal direction so as to prevent it from walking away. To this end, each automatically displaceable arm 54, 54′ comprise a body-engaging portion for holding the animal to prevent a movement, in this case a forward movement. In the present example, the body-engaging portion is a neck-engaging portion 64, which comprises a bumper 68. More specifically, a respective bumper 68 is rotatably mounted at the distal end of the automatically displaceable arms 54, 54′. In this example, for added versatility, the neck-engaging portion 64 of each automatically displaceable arm 54, 54′ comprises respective bumpers 68 and a displaceable support 66 connecting the bumper 68 to the rest of its arm in a mobile way. Practically speaking, the bumper 68 may comprise a padding around a solid core that is rotatably supported by (as in this example), or otherwise mounted to, the rest of the arm (here, the displaceable support 66). The displaceable support 66 is rotatably or pivotably attached to the end of the second link 62 at the distal end of the respective automatically displaceable arm in such a way as to be able to pivot towards and away from the domestic animal when the arm is in the working configuration. The connection between the displaceable support 66 and the second link 62 is called the wrist joint herein for continuity with the other anthropomorphically named joints. In practice this displaceability allows the neck-engaging portion 64 to have an open and a closed configuration. The closed configuration would typically be used when the respective automatically displaceable arm is in the working configuration. In it, the bumper 68 is rotated towards the neck of an animal, which in this example is towards the inside of the space between the two automatically displaceable arms 54, 54′. Preferably the closed configuration is such that when the automatically displaceable arms 54, 54′ are in the working configuration the bumpers 68 engage the neck of the domestic animal.

In the open configuration, the bumper 68 is rotated in the other direction, for example away from the longitudinal direction of the second link 62 away from the space between the automatically displaceable arms 54, 54′. There may be other open configurations. For example if the animal processing device 10 is intended to be used in very tight areas, an open configuration may be used where the displaceable support 66 is coaxial with the rest of the automatically displaceable arm in the longitudinal direction and the bumper 68 is therefor straight ahead of the second link 62. Generally, the open configuration may be adopted when the automatically displaceable arms 54, 54′ are moving between the stowed configuration and the working configuration so as to ensure that the bumper is not in the way of a properly-positioned domestic animal and/or to catch the domestic animal if it is off to the side of the proper position.

In a specific, non-limiting example of implementation, some of, or each joint in the automatically displaceable arms 54, 54′ (including the shoulder joint, elbow joint and wrist joint) includes spring-loaded bearings and an actuating device (e.g. an electric step-motor) for folding/unfolding the links 60, 62 of the automatically displaceable arms 54, 54′ or for rotating the neck-engaging portion 64 about a vertical axis.

The animal controlling mechanism 16 has position adjusting mechanism for automatically adjusting an extension of the side restraining arms 54, 54′, and thus of the bumpers 68, allowing to accommodate for animals of different sizes (e.g. length of the animal). In a specific, non-limiting example of implementation, the position adjusting means consist of, for each side restraining arm 54, 54′, a respective telescopic cylinder 70 supporting the first link 60 at or around a mid-length point thereof, where each cylinder 70 is pivotably mounted to the base 14 and driven by a respective actuating device (e.g. an electric step-motor). In accordance with position adjustability, the automatically displaceable arms 54, 54′ may have a plurality of working configurations, suited for different animal sizes. As such, the automatically displaceable arms 54, 54′ need not always be in the exact same position, orientation, etc. . . . when in the working configuration.

When the animal processing device 10 is displaced along the track 30, the animal controlling mechanism 16 is in the stowed position shown in FIG. 1. In the stowed position, the articulated arms 54, 54′ are tucked towards the vehicular body to allow unimpeded displacement thereof. To this end, in this example, the elbow joint 61 is closed, meaning that the first and second links 60, 62 are folded together. In this example with the links 60, 62 being collapsed together, the first link 60 has a slot for receiving therein at least a portion of the second link 62 and the neck-engaging portion 64 are rotated outwardly in an open configuration such that the displaceable supports 66 are parallel to the horizontal top beam 56 of the beam structure 52.

The animal milking machine comprises animal operation equipment 99 to perform an operation involving an animal. In this example, the animal operation equipment 99 includes a milking head 92 and an animal controlling mechanism 95, which comprises the automatically displaceable arms 54, 54′ to immobilize an animal for milking. The vehicular body 11 is displaceable to reach individual animals. In this example, the vehicular body is in a stall environment and is displaceable to the rear opening of particular stalls in the stall environment. In particular the vehicular body 11 is displaced to orient the animal operation equipment 99 and more particularly the animal controlling mechanism 95 with the rear opening of a stall.

In this example the device is a dual milking machine, and comprises two animal operation equipments 99 and 99′. The animal operation equipment 99′ of this example is substantially identical to animal operation equipment 99, however in alternate designs, modifications could be made, e.g. to accommodate different stall geometries or different animals or different positioning with respect to the vehicular body 11. In general, the two animal operation equipment 99, 99′ and in particular the animal controlling mechanisms 95, and in particular still the automatically displaceable arms 54, 54′ of the two animal operation equipment 99, 99′ are spaced apart to face the rear openings of respective stalls when the vehicular body is in position, and the vehicular body 11 is configured to orient the two animal operation equipments 99, 99′ with the rear opening of respective stalls. In this example, the two animal operation equipment 99, 99′ are spaced on opposite sides of the vehicular body 11 such that they may simultaneously face respective stalls when the vehicular body 11 in a central alley and is lined up with the stalls. Although in this embodiment two animal operation equipments 99, 99′ are provided, additional ones, e.g. side-by-side with the current ones and spaced apart to face the next two stalls over, may be provided for even more simultaneous operations servicing domestic animals.

For the purpose of describing the animal operation equipment and the function thereof, a description will be given with respect to one stall using animal operation equipment 99 as example, with the understanding that similar teachings can be applied for the other animal operation equipment 99′. When the animal processing device 10 is stopped behind a rear opening of a stall and the displaceable bridge 18 has been extended over the gutter 40 to rest on the ledge of the stall, the animal controlling mechanism 16 is gradually extended to a working configuration, each automatically displaceable arm 54, 54′ extending on a respective side of a domestic animal, for example a cow. The neck-engaging potions 64 are first rotated inwardly such that the horizontal supports 66 are present an open configuration wide enough to receive the domestic animal. In this example, they are substantially perpendicular to the horizontal top beam 56. The automatically displaceable arms 54, 54′ are then unfolded (the second link 62 being unfolded from the first link 60), such that the neck-contacting portion 64 extend towards the head of the cow. Note that the automatically displaceable arms 54, 54′ are positioned along the top beam 56 with sufficient space therebetween to be able to accommodate the standard width of a cow, such that the neck-engaging portions 64 will typically not engage the body of the cow during their extension towards the head of the cow. However, if such engagement between the bumpers 68 of the neck-engaging portions 64 and the body of the cow occurs at some point, the bumpers 68 will simply slide along the body of the cow, moving up to the neck area of the cow providing a pressure to encourage the animal to shift laterally to center itself relative to the machine. As the automatically displaceable arms 54, 54′ gradually extend outwardly, the cylinders 70 simultaneously pivot outwardly and, if necessary to accommodate for the size (e.g. length) of the animal, telescopically extend to support the necessary extension of the automatically displaceable arms 54, 54′.

In a specific example, the position adjusting mechanism also include, for at least one of the automatically displaceable arms 54, 54′, one or more monitoring sensors, such as a proximity sensor, provided in the respective neck-engaging portion 64 allowing to determine when the extension of the automatically displaceable arms 54, 54′ needs to be adjusted to accommodate a longer animal, as well as when the neck-engaging portions 64 need to be rotated further inwardly to adjust to the narrower neck area of the cow and maintain contact with the body of the cow. Moreover, the controller unit can also accommodate different animal heights, by reducing the angle of the elbow joint 61 of the automatically displaceable arms 54, 54′ and rotating the first link 60 upwards from the shoulder joint.

As mentioned above, the animal processing device 10 may advantageously process the domestic animal in its stall. To this end, the articulated arms 54, 54′ can achieve a working configuration wherein the arm is confining, immobilizing or more generally constraining the animal to process it, in this example to milk it. To this end, when the neck-engaging portions 64 reach the neck area of the cow, the automatically displaceable arms 54, 54′ may be considered to have reached working configuration and the neck-engaging portions 64 may be stopped on, or in close proximity to, the neck of the domestic animal, e.g. cow. Thus the neck-engaging portions 64 prevent forward motion of the animal by creating an obstruction in front of the neck or shoulders or other front portion of the animal while other parts of the automatically displaceable arms 54, 54′ constrain the rear or whole side of the animal to prevent its lateral movement. Preferably the neck-engaging portion 64 continues to applies constant pressure against the neck of the cow and prevent the cow from stepping away during processing. In this position the animal may be constrained and if the rest of the animal operation equipment 99 is suited for performing the operation in this position, e.g. if the milking head can reach the animal, it may be done.

Although the animal processing device 10 immobilizes, constrains and processes the domestic animal in the stall, it may still be desired to position the animal for processing within the stall, for example to bring it closer to the animal processing device 10 or to bring its hind legs over a hind leg spreader to allow processing equipment to be extended therebetween. In the illustrated example, the automatically displaceable arms 54, 54′ are configured to automatically position the domestic animal to position it to a position for processing by pulling it back with the neck-engaging portion so as to cause the domestic animal to back up. Thus the animal processing device 10 causes cows to back up to bring their hind legs over the bridge 18, which contains the spreader. Although the domestic animal may thus have a portion of its body protruding from the stall, it is still considered to be in the stall because the majority of the animal is in the stall. Because the cow remains in the stall, it does not need to be untied from the tether that keeps it within the stall or otherwise have the tether loosened. This provides an advantage over prior devices that required animals to enter a machine for processing for the aforementioned reasons. To this end, when the neck-engaging portions 64 reach the neck area of the cow, the cow is centered with respect to the bridge 18, pressure is maintained by neck-engaging portion 64 and the side restraining arms 54, 54′ are slowly retracted. This causes the cow to back-up slowly until its hind legs are properly positioned on the displaceable bridge 18, which has been extended over the gutter 40 behind the cow's stall. Once in this position, with the cow's rear end positioned on the bridge 18, a task can be performed on the cow as it is retained by the neck-engaging portion 64, which remain in contact with, or near to, the neck of the cow. Preferably the neck-engaging portion 64 continues to apply constant pressure against the neck of the cow and prevent the cow from stepping off of the bridge 18 during processing. Simultaneously, the automatically displaceable arms 54, 54′ constrain the rear or whole side of the animal to prevent its lateral movement. Thus at this point a working configuration is achieved wherein the animal is immobilized in the lateral direction.

As already described, in this example, the displaceable arms 54, 54′ are articulated arms 54, 54′having a first and second link member 60, 62 joined at an elbow 61. Advantageously, this configuration permits a construction that is sufficiently robust to withstand pressure in the lateral direction and constrain animals. In particular, when the articulated arms 54, 54′ are in the working configuration, the elbow joint 61 is partially opened such that the first and second link members 60, 62 form a V shape. In this example a right-side-up V shape, but in an alternate examples the V shape could be oriented differently, for example in the alternate embodiment where the first link member is a rising member and the second link member is a falling member, the V shape could be upside-down. It will also be noted that additional link members could be included, e.g. connected by additional joints to further extend the reach of the articulated arms 54, 54′, which may add additional V shapes (e.g. an N shape, which comprises two V shapes or a W shape, which comprises three V shapes) to the articulated arms 54, 54′. With the elbow joint 61 partially opened, the articulated arms 54, 54′ expand in both the longitudinal and the vertical direction to provide better coverage of the constrained animal's side, particularly where the size of the constrained animal may vary. As such this allows more effective immobilization of the animal in the lateral direction. This geometry may also provide a stronger rigidity to the articulated arms 54, 54′ under certain constructions.

Note that in a tie-stall environment, each animal is typically provided with a neck collar having a chain secured thereto and engaging a front metal rod of the respective stall. Since the animal can be processed within the stall, it is sufficient that the tether be long enough for the animal to be in position for processing while attached. This can be done by providing a long enough tether for the animal to back up to the desired position or by causing the automatically displaceable arms 54, 54′ and processing equipment to extend far enough towards the animal.

In a specific, non-limiting example of implementation, the animal controlling mechanism 16 is fully motorized and electronically controlled by the controller unit. More specifically, each actuating device (e.g. step-motor) of the animal controlling mechanism 16 is powered on and off by the controller unit as necessary, where these actuating devices are synchronized to ensure substantially simultaneous extension and retraction of both side restraining arms 54, 54′.

Advantageously, the animal controlling mechanism 16 is easily adjustable, both in terms of the extension and rotation of the side restraining arms 54, 54′, and thus of the neck-engaging portion 64, which is extremely beneficial when the animal processing device 10 is engaging animals that vary significantly in size (e.g. longer animals). To this end, each of the joints in the articulated arms 54, 54′ may have and be actuated by respective actuators, e.g. step motors, for individual control by the controller. In the example shown the elbow joint 61 is articulable to allow movement of the articulable arm 54 in a vertical direction, for example by causing the second link member 62 to pivot about the elbow joint so as to raise or lower the distal end of the link member, and the articulable arm 54. Advantageously, since the elbow joint 61 is actuated by a step motor that is individually controlled by the controller, this allows fine tuning of the final position of the body-engaging portion of the articulable arm 54, and indeed of the articulable arm 54 as a whole.

As mentioned, the other joints of this example are also individually actuable, for example the shoulder joint 55 is actuated by an integrated step motor that is individually controlled by the controller. This allows for an even finer control of the position of the articulable arm 54 according to a two-degree-of-freedom control. For example, if an animal is particularly long, which requires an wide opening of the elbow joint 61 and is also tall, the elbow joint 55 may be actuated to raise the distal end of the articulable arm 54.

In this example, the automatic animal processing device 10 is primarily an electronically controlled system, in contrast to the prior art systems which are primarily hydraulically controlled. Advantageously, electronically controlled, motorized components that must interact with and engage an animal are much safer than hydraulically controlled components, where the force applied by the motors can be programmed and controlled and these motors can be monitored to determine how hard they are working and, as a result, to quickly identify a problem or dangerous situation for the animal. The actuators or other sensors also read the position of the joints and resistance forces against the movement thereof, which is provided to the controller, and are controlled by the controller to adjust the actuating forces to be softer on the animal than hydraulic systems would be. This allows for an intelligent machine that can delicately train an animal to work with it by applying soft (and optionally progressively stronger) forces on the animal to urge it into the proper position. Furthermore, the use of electronic versus hydraulic components, combined with the use of a lighter metal material (e.g. aluminium versus a rigid metal), provides for a significant reduction in the weight of the machine, as compared to the prior art systems. Even with the dual animal controlling mechanisms 16, the automatic animal processing device 10 may be characterized by a weight of less than 3000 pounds, for example. In a specific, non-limiting example of implementation, the animal processing device 10 weighs between 2700 and 3000 pounds, which is lighter than the prior art systems and thus does less damage to the floor of the building and is easier to manoeuvre within the building, as well as to maintain. Electrical motors may be provided in the various moving parts such as the joint of the automatically displaceable arms 54, 54′, the joints of the mechanical arm assembly 102, the brushing mechanism, and the bridge 18. Advantageously, this allows direct control of each part for straightforward programming of the controller unit, fine programmatic control of individual components for simple and precise operation. It also allows for responsiveness to external influences and forces, to permit, for example immediate halt of a movement if an obstruction is detected. This allows for a much safer design.

The controller unit comprises logic for controlling the operation of the animal processing device and its constituent parts. The logic may be in software (e.g. computer-readable instructions stored on a tangible storage medium for instructing a processor to control the animal processing device's electrical components to perform the tasks described herein) or hardware (e.g. a field-programmable logic array programmed to cause electrical outputs to control the animal processing device's electrical components to perform the tasks described herein) or a combination of the two. In particular, the controller unit is programmed to control relays, actuators, and/or electric motors and other electric components of the animal processing device 10, including the motorized propulsion system and the electric motors of the automatically displaceable arms 54, 54′, the mechanical arm assembly 102, the bridge 18 and the brush mechanism to perform the functions described herein including to move the animal processing device from to a first stall's rear opening, deploy the automatically displaceable arms 54, 54′ to immobilize and constrain a domestic animal in the stall, deploy the processing equipment o process the animal (e.g. to milk it), retract the processing equipment and the automatically displaceable arms, clean the processing equipment and/or other parts of the animal processing device 10, and move the animal processing device 10 to the next stall, and repeat the process. It will be noted that although this description talks about single stalls this process can be done simultaneously on stalls on the opposed side of an aisle in which the animal processing device 10 operates when the animal processing device 10 is a double-sided device. The controller unit is programmed to undertake the tasks of the animal processing device 10 described herein.

As mentioned above, in a specific, non-limiting example of implementation, each neck-engaging portion 64 of the animal controlling mechanism 16 may include a monitoring sensor (or eye), such as a proximity sensor, that can effect supervision of various operations and, more specifically, detect and monitor the presence, size and/or position (e.g. standing or lying down) of an animal in its stall. If both neck-engaging portions 64 of an animal controlling mechanism 16 include such a monitoring eye, it becomes possible to not only monitor the animal in the stall currently engaged by the animal processing device 10 prior to actuating the displaceable bridge 18, but also to monitor the animals in the adjacent stalls on either side of the currently engaged stall. The controller unit of the animal processing device 10 is responsive to the output of the monitoring sensors to automatically transmit status and/or alarm signals back to the remote computing unit, where these signals may be processed by a control system and/or monitored by an operator or attendant of the system.

A proximity sensor is operative to sense the presence or absence of a nearby object (e.g. an animal) without any physical contact, for example using an electromagnetic field or a beam of electromagnetic radiation (e.g. infrared) and checking for changes in the field or return signal. Different types of proximity sensors exist and may be used to implement the monitoring eyes of the neck-engaging portions 64 of the animal controlling mechanism 16, including for example capacitive sensors, photoelectric sensors and inductive sensors, among other possibilities. Since such proximity sensors have been well documented and are well known to those skilled in the art, their functionality will not be described in further detail herein.

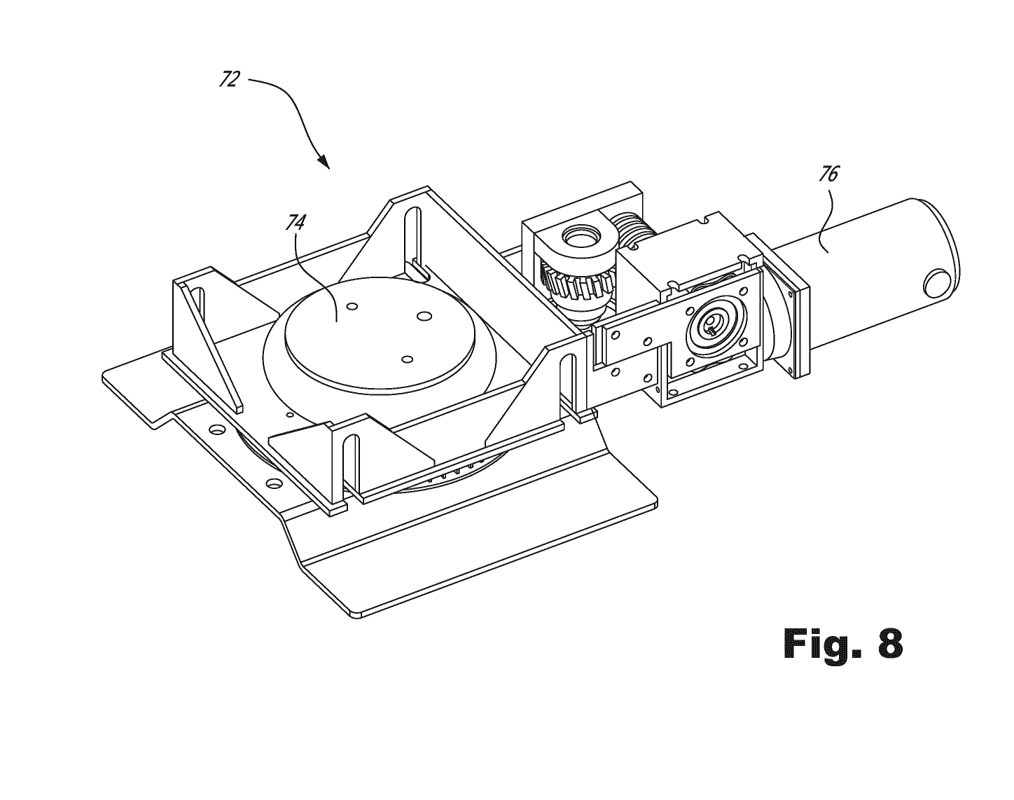

In another specific, non-limiting example of implementation, each neck-engaging portion 64 of the animal controlling mechanism 16 may also include a motorized arm fixture that can act as a whip and, optionally, generate an electrical shock, for example as shown in FIG. 9 and FIG. 10. Thus, if, for example, the monitoring sensor of a neck-engaging portion 64 detects that a cow in the currently engaged stall, or in the adjacent stall to be engaged subsequently, is lying down, then the arm fixture 78, which optionally has an electric tip 80, may be activated and advanced towards that cow to apply a whipping sensation to the cow's body. If the cow does not rise in response to the whipping by the arm fixture 78, then the electric tip 80 of the arm fixture 78 can controllably give the cow a light, electrical shock for causing the cow to rise. If the cow still does not rise, the animal processing device 10 will skip that particular cow, moving onto the next stall; however, the controller unit may be programmed to transmit a message or an alarm to the remote computing unit to indicate that the cow may be sick or in need of help to remedy the situation.

Advantageously, if the monitoring sensor and motorized arm fixture are provided in both neck-engaging portions 64 of the animal controlling mechanism 16, the animal processing device 10 can start its processing of the animals from either end of the row of stalls (moving in either directions down an aisle), since cows on either side of the currently engaged stall can be monitored and, if necessary, prodded or encouraged to acquire the appropriate position.

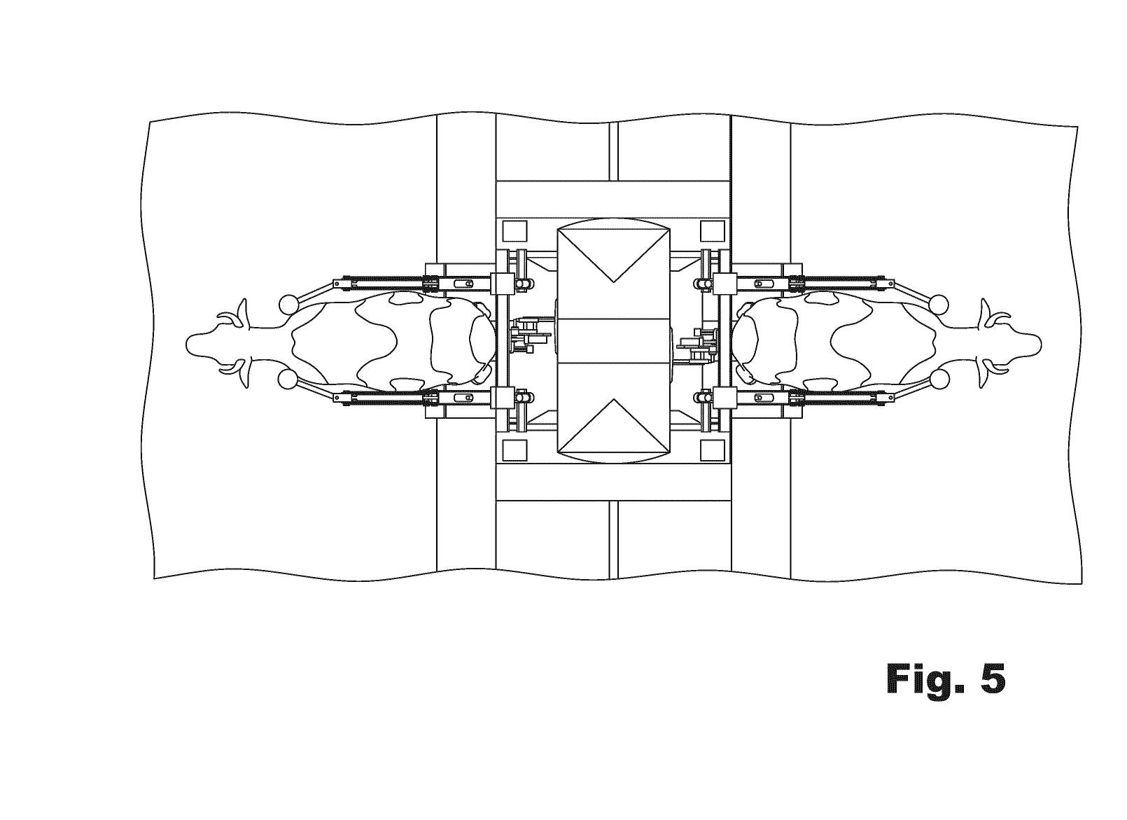

In one particular embodiment, the animal processing device 10 is capable to support a pair of animal controlling mechanisms 16 and optionally a pair of displaceable bridges 18, provided on opposite sides of the housing 12, as shown in FIGS. 4 and 5. Accordingly, as the animal processing device 10 travels along the track 30, the animal processing device 10 is able to process a pair of cows simultaneously, the two cows being located in stalls opposite one another on either side of the track 30. More specifically, the controller unit is operative to simultaneously control the operation of both animal controlling mechanisms 16 (and both bridges 18) on the animal processing device 10, such that a pair of animals can be positioned and processed substantially simultaneously.

One of the advantages of the animal processing device 10 is that it allows the processing of domestic animals in the stall. Many prior art devices aimed for free-stall environment require the domestic animals to go to the machine for processing. While this may be acceptable in a tie-stall environment, it is not practical in a tie-stall environment where animals are tied in their stall and furthermore does not allow the same degree of control over, e.g., the timing of processing operations such as milking. Even prior devices designed for tie-stall environment required domestic animals to be displaced considerably, e.g. into a machine, for processing. Having to accommodate an animal in a machine places considerable constraints on the design; the machine must necessarily have a certain size, and bulk in order to accommodate animals, especially heavy ones such as cows. Accordingly such devices will necessarily be heavier, which affects speed and cost of construction and operation, and cannot be made to accommodate more than one animal at a time. Being limited in speed and multitasking ability, such devices cannot service more than a limited number of animals, if the processing is to be done on each animal on a regular basis, as is the case with milking. In contrast a lighter, faster machine like the animal processing device 11 may be able to service many more animals, all the more so if the machine can process more than one animal at a time.

As mentioned above, the animal processing device of the illustrated example is a milking machine and in the particular example shown, it is a dual animal milking machine configured for processing two animals at the same time. This makes it possible to process a set of animals more quickly which in turns permits the machine to service a greater number of animals such that a single machine may be installed in larger sized barns. In addition, the dual nature of animal processing device is used to provide a redundant backup system in case of failure of, or more broadly speaking of a defect in one of the pair of animal operation equipment 99, 99′. To this end, the processing device is provided with two operation modes, a full operation mode whereby each of the animal operation equipments 99, 99′ function simultaneously to perform simultaneous milking operations on two animals and a half operation, useful in case of a defect in one of the two animal operation equipments 99, 99′, whereby one of the animal operation equipments services each of the two animals that would be serviced by different animal operation equipments 99, 99′ in the full operation mode. It should be noted that the term simultaneous here is intended to mean overlapping in time. While the dual milking machine performs an animal operation, namely a milking operation, on two animals simultaneously, this does not mean that both operations are identical, and perfectly timed such that every step of the milking occurs simultaneously, rather each operation includes at least a portion that overlaps with the other operation. In the one example, any portion of the animal operation, e.g. the deployment of the automatically displaceable arms 54, 54′ or the drawing of milk from the animal might overlap with any portion of the other animal operation to consider that they occur simultaneously. In another example, the dual milking machine may operate both animal controlling mechanisms followed by operating both milking heads such that individual parts of the two animal operations are simultaneous. In yet another example, the entire procedure may occur identically on both animal operation equipment.

The animal processing device comprises a stall transfer mechanism under control of the controller which is used in half operation mode to transfer the animal operation equipment from the stall it would service in full operation mode to the stall that would be serviced by the animal operation equipment in full operation mode. In this particular example, where the two animal operation equipment 99, 99′, are located on opposite sides of the vehicular body 11, the transfer mechanism is a turning mechanism that turns the vehicular body 11 around so that the position of the two animal operation equipments 99, 99′ are inversed. Taking an example of half operation mode in which the animal operation equipment 99 is services both of a pair of domestic animals in respective stalls where one of the pair of domestic animals would have been serviced by animal operation equipment 99′ if in full operation. The animal operation equipment 99 may service the two animals in any order. In this example the servicing performed in the performing of a milking operation.

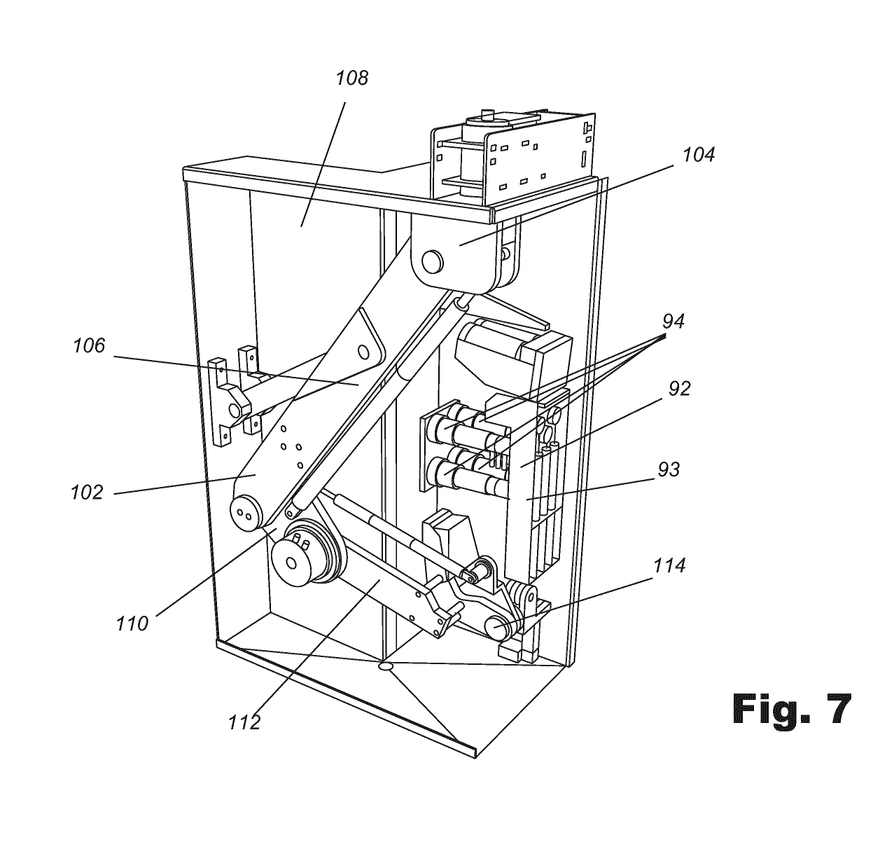

In the present example, the stall transfer mechanism is provided on the base 14 and includes an elevator mechanism driven by the controller unit of the animal processing device 10, where this elevator mechanism is operative to raise and lower the housing 12, as well as to rotate the housing 12. In a specific, non-limiting example of implementation, the elevator mechanism is a scissor lift that may be mounted to the underside of the base 14, for example as shown in FIG. 8. The scissor lift 72 is a motorized structure having a platform 74 supported by criss-crossing metal supports (not shown), the motor 76 that drives the scissor lift being controlled by the controller unit of the device 10 to either cause the scissor lift 72 to raise, lower or rotate (e.g. by 90 degree turns) the platform 74, and thus the housing 12. As the metal supports of the scissor lift 72 are elongated, the platform 74 is raised, thereby raising the housing 12 off of the ground. As the metal supports collapse, the platform 74 is lowered, thus lowering the housing 12 back down to the ground. The motor 76 is electronically controlled by the controller.

Accordingly, the elevator mechanism of the base 14 is a pivoting mechanism that pivots the vehicular body 11 to reverse the sides of the two animal operation equipments. More specifically in this example it is controllable to lift the animal processing device 10 (or animal operation equipment 99, 99′ in this case) and to rotate the machine, for example by 90 degree turns, which may be useful for maintenance of the animal processing device 10 to give easy access by an operator to the various components of the animal processing device 10 (e.g. wheel changes, bridge repairs, etc.) although the animal processing device is conveniently designed to allow access to certain important components when the device is oriented for operation. The elevator mechanism is controllable to rotate the animal processing device 10 by 180 degree turns to effect a stall transfer described above, which is useful for providing redundancy in the animal processing device 10.

Advantageously, since the animal processing device 10 has an elevator mechanism that can rotate the device 10 by 180 degree turns, each of the pair of animal controlling mechanisms 16 can provide redundancy for the other, that is can act as a backup in case the other fails or malfunctions. Similar redundancy is provided by the pair of displaceable bridges 18, as well as by any other duplicated equipment or specialized machinery mounted in the housing 12 or on opposite sides thereof, which redundancy is enabled by the rotatability of the animal processing device 10 by its elevator mechanism. Thus, as the animal processing device 10 travels along the track 30 to process cows located in stalls on either side of the track 30, it is possible for the animal processing device 10 to process a first cow in one stall on one side of the track 30 and then to rotate by 180 degrees to process a second cow located in the opposite stall on the other side of the track 30 using the same animal controlling mechanism 16, displaceable bridge 18 and specialized machinery. This is useful when one of a pair of mechanisms, equipment or machinery malfunctions or breaks down. Though the speed of operation and processing capacity of the animal processing device 10 is reduced by half in such a scenario, this redundancy allows the animal processing device 10 to continue operating without interruption, for example until a technician is available to address and repair the malfunctioning or broken mechanism/equipment/machinery.

In alternate examples, other elevator mechanisms may be used. In particular, instead of the scissor lift, other lifting technologies may be used, such as an air suspension system for lifting the animal operation equipment 99, 99′. The rotation may be provided by a pivoting mechanism which may be suitable electric motor in mechanical connection with the lifted portion and the unlifted portion, for example a base, to provide pivoting motion therebetween. Such electric motor may be in electrical communication with and under control of the controller, as is the elevator mechanism and the controller may be provided with logic for implementing a full or half operation mode by causing the elevator mechanism to lift the vehicular body 11, or the animal operation equipments 99, 99′, and to cause a rotation of the lifted portion by the pivoting mechanism and, once this is complete, to cause the elevator mechanism to lower the lifted portion back down. The stall transfer mechanism may be implemented differently to accommodate different dual animal devices. For example, if the two animal operation equipments 99, 99′ are located spaced apart for processing animals in respective side-by-side stalls, the stall transfer mechanism may provide a translational, rather than rotational, motion to the animal operation equipment 99 and/or 99′, an may comprise for example a rail system on the vehicular body 11, or may be implemented by applying a transfer function to the locomotion equipment of the vehicular body 11.

The controller, as programmatically implemented in software or as programmed into a hardware design such as an FPGA implements, is configured to choose an operation mode for the animal processing device 10 and to put into effect the operation mode by controlling the operation of the various components of the animal processing device 10 including the animal operation equipment 99, 99′ and the stall transfer device as described herein to cause either one or both of the animal operation equipment 99, 99′ to undertake an animal operation, specifically here a milking operation, and/or to cause the stall transfer device to transfer an animal operation equipment to another stall, in this case to inverse their position. The controller may be set to be in full operation mode by default.

In the present example, given the operational symmetry of the animal operation equipment 99 and 99′, the processing device 10 may enter half operation mode using either one of animal operation equipment 99 and 99′.

The controller may be provided with logic for making a determination that there is a defect in one of the pair of animal operation equipment 99, 99′, and to cause the adoption of the half operation mode on the basis of the defect detection. To this end, the processing device 10 may be provided with state sensors in communication with the controller for providing information on the state of the animal operation equipment (e.g. component positions) to the controller to detect whether components are responding properly to controller instructions. Broadly speaking a defect can be anything preventing an animal operation equipment from performing its function, which may include equipment failures or blockage which can be detected by such sensors. Other types of defects may include maintenance scheduling, worn out parts, faulty sensors, equipment that does not match the job required, an empty cleaning fluid or additive reservoir, unresponsive parts, or even a full milk reservoir. In many instances, a defect may occur with respect to only one of the two animal processing equipment 99, 99′. In such a case, the controller upon detecting a defect notes which of the two animal processing equipment 99, 99′ is affect and if one is unaffected, the controller causes a shift to the half operation mode as described herein.

In one example of operation the animal processing device is operating in a full operation mode and the controller monitors state sensors to determine whether a defect has occurred. The controller receives state sensor information indicative of a defect affecting only one of the animal operation equipment. The controller detects the defect and in response the controller causes the entering of the half operation mode using the unaffected animal operation equipment. In the half operation equipment, the controller causes the functioning animal operation equipment to perform an animal operation on one animal which the functioning animal operation equipment would have serviced in full operation mode. The controller also causes the functioning animal operation equipment to perform the animal operation on another animal which the functioning animal operation equipment would not have serviced in full operation mode. In this particular case both animals are in respective stalls and the animal operations are milking operations as described herein. According to particular examples, the two animal operations can occur in either order, but the controller controls a stall transfer mechanism to cause the movement of the animal operation equipment from one stall to the other as described herein in order to service each animal. Once both animals have been serviced, if there remain other animals to service, the controller causes the vehicular body to be displaced to the next animal(s) to be serviced and if there are two which would have been serviced by respective ones of the two animal operation equipments in full operation mode, the controller repeats the step of servicing both under half operation mode using the functioning animal operation equipment.

Although redundancy was described herein in the context of a dual milking machine, it will be appreciated that it could be applied in other context, for example if more than two animal operation equipment were provided if an appropriate transfer mechanism exists. A half operation mode allows an animal operation equipment to perform an animal operation on an animal that would otherwise be serviced by another animal operation equipment. In this example the animal milking machine was a dual milking machine which comprises two animal operation equipments 99, 99′. If more animal processing equipments are provided in a configuration that permits simultaneous operation, the dual milking machine may also be a triple milking machine or more. Such multiple-animal processing devices with a greater number of animal operation equipments, may have more than one half-operation mode. In one example, the dual animal milking machine may be a quadruple animal milking machines comprising an additional two sets of animal processing equipment next to the animal processing equipments 99, 99′ of the device 10 such that four animals can be services simultaneously: two in side by side stalls on either sides of a central aisle. In such an example, the stall transfer mechanism may comprise the same scissor lift mechanism described above for pivoting the vehicular body but may also include the locomotion equipment for displacing the vehicular body so as to move on piece of animal processing equipment from the stall it is facing to the side by side adjacent piece of animal processing equipment is facing. In this example of multiple different half operation modes, there may be a single-equipment half operation mode whereby a single one of the four animal operation equipment services all the animals that would otherwise be serviced by all the four animal operation equipments. To do so, the vehicular body will be moved to align in sequence the working animal processing equipment with both stalls on its side, then pivoted and translated to align the same animal processing equipment with the two stalls on the other side. There may be also be two-equipments half operation modes whereby two of the animal processing equipment services all four animals that would otherwise have been services by all the animal processing equipments. For example, if only the two animal processing equipments on one side of the vehicular body are used, they may first service animals on one side, then be pivoted to face the stalls on the other side to service animals there. Likewise in another two-equipment half operation mode, two back-to-back animal processing equipments may service animals on respective sides of the central aisle and be translated to face the next stall that would otherwise have been serviced by the other onboard animal processing equipments.

Oftentimes a defect may require a technician intervention. However, certain animals need to be milked with a certain frequency or risk being hurt or injured for want of milking. In such cases, the half operation mode may reduce the speed of operation but may safeguard the health of the animals processed by the animal processing device 10 until technician intervention can occur.

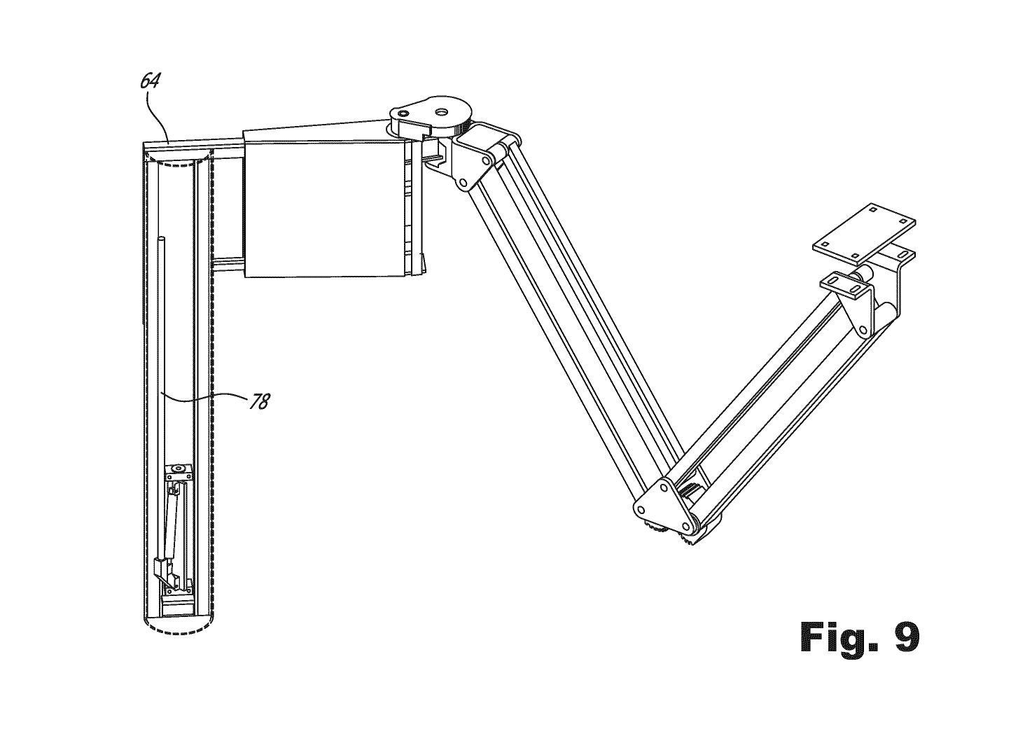

In another specific, non-limiting example of implementation, the animal processing device 10 may include a grooming mechanism mounted to the vehicular body 11. In this example, a brushing mechanism is mounted to the top beam 56 of each animal controlling mechanism 16. In the non-limiting example shown in FIG. 11, the brushing mechanism 82 comprises a large motorized brush 84 having a concave shape and supported on a motorized, folding arm structure 86 that can be pivotably attached to the top beam 56. The movement of both the brush 84 and the folding arm structure 86 of the brush assembly 82 are controlled by the controller unit, the arm structure 86 being similar in construction and operation to the folding side restraining arms 54, 54′ although it can be made smaller and lighter being not subject to the same forces. The brush 84 itself is rotatable with respect to the supporting arm structure 86. In operation, when the animal processing device 10 is processing an animal, the brush assembly 82 can be activated by the controller unit to brush the animal. More specifically, the controller unit directs the extension, retraction and pivoting of the folding arm structure 86 of the brush assembly 82, as well as the rotation of the brush 84, in order to orient the brush 84 at different positions to brush the back, sides and rear of an animal's body.

Advantageously, since all of the extending/retracting arms of the a animal processing device 10 are mounted to the frame 53 (as opposed to the housing), the animal processing device 10 is smaller in height than the prior art systems, which affords greater flexibility of the machine and allows for its use in buildings (e.g. barns and farms) with lower ceilings. Moreover the absence of a cage allows the animal processing device 10 to process large animals, like large cows, without height restriction. Cage-based machines suffer from the problem of being designed for a certain animal size and with machine size restrictions which means that occasionally animals (e.g. cows) may be too large for the machine.

The animal processing device 10 includes a cleaning system operative to clean at least one of the interior and exterior of the housing 12, the base 14, as well as possibly the animal controlling mechanisms 16, after each animal (e.g. cow or pair of cows) is processed by the animal processing device 10. In a specific, non-limiting example of implementation, the housing 12 is equipped with at least one water source via at least one long hose supported at one end on the housing 12, as well as one or a plurality of pressurized fluid jets via at least one air conduit connected to the housing 12. These air/water jets may be installed at multiple different locations on the animal processing device 10, enabling top to bottom, and inside out, cleaning of the device 10. Once the animal processing device 10 has processed an animal, and that animal has been released from the animal controlling mechanism 16, all machinery is retracted back inside the housing 12, all doors and panels of the housing 12 are closed and the cleaning system uses the water and air jets to clean either the inside, the outside or both the inside and the outside of the housing 12. This cleaning process may be controllably initiated by the controller unit via an operator or, alternatively, may be an automatic operation triggered by the completion of processing and the closing of the housing 12.

Note that the housing 12 may be provided with a drainage system for draining the water used during the cleaning process. In one example, this drainage system includes at least one drain defined in a wall of the housing 12 or in the base 14, as well as a conduit for collecting the water draining out of the drain and delivering this water to a remote location or drain.

As mentioned above, the animal processing device 10 may optionally include a bridge cleaning mechanism for cleaning both the bridge 18 and the stall cleaning mechanism 42 during their retraction movement. Though this bridge cleaning mechanism is independent from the cleaning system of the animal processing device 10, its operation is similar in that the base 14 and/or the bridge 18 are equipped with at least one pressurized water jet, for example mounted on the underside of both the base 14 and the bridge 18. In a specific, non-limiting example of implementation, these water jets are controllably initiated by the controller unit, or automatically triggered, during retraction of the stall cleaning mechanism 42 and/or the bridge 18, for hosing down these components as they move back to their respective retracted positions.

The bridge cleaning mechanism may also include a scraping mechanism for scraping the top surface of the bridge 18 during its retraction back into the base 14. In a specific, non-limiting example of implementation, this scraping mechanism consists of one or more motorized scraper plates rotatably mounted (e.g. hinged plates, pivotal plates, telescopic plates) to the underside of the base 14, above the bridge 18. When not in use, each scraper plate lies against the underside of the base 14, out of contact with the bridge 18; however, before retraction of the bridge 18 into the base 14, each scraper plate is pivoted downwardly such that the scraper plate will contact and scrape the top surface of the bridge 18 as it moves back into the base 14. Once the bridge 18 is fully retracted, each scraper plate of the bridge cleaning mechanism is pivoted upwardly, so that it once again lies against the underside of the base 14. Note that the scraping mechanism of the bridge cleaning mechanism may be actuated by a motor driven by the controller unit and mounted on the underside of the base 14. However, various other suitable mechanisms for mounting the scraping mechanism to the base 14, as well as for actuating the movement of the scraping mechanism, can be contemplated.

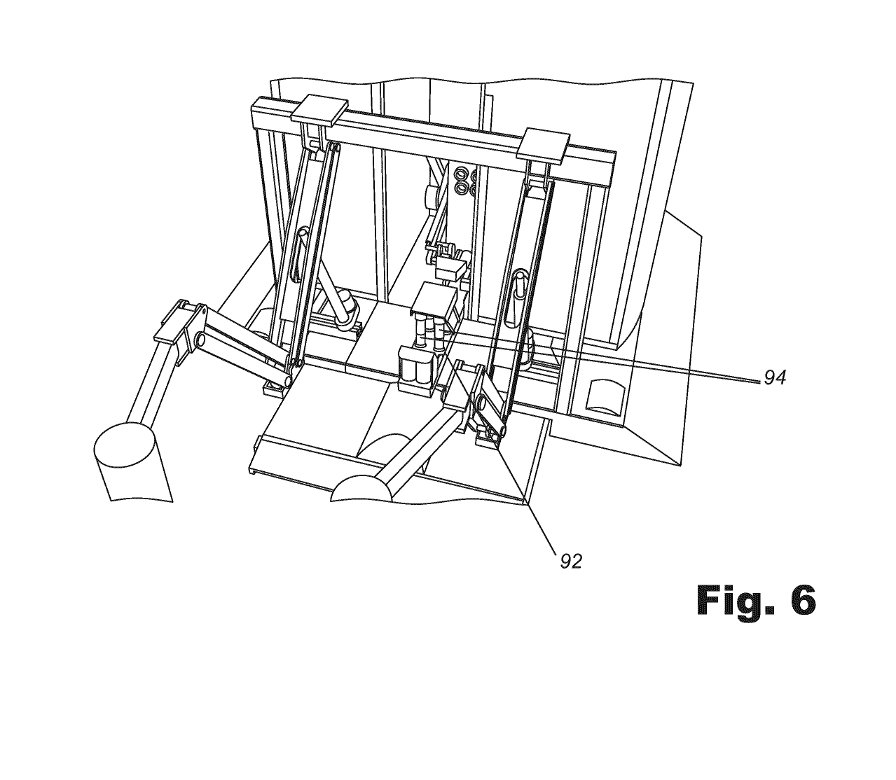

As discussed above, the animal processing device 10 may include processing equipment 90 to process domestic animals. With reference to FIGS. 6 and 7, a specific example of such processing equipment is robotic milking equipment for milking cows. In the present example, a milking head is adapted for use in processing equipment 90. The milking head 92 the machine can be mounted on a motorized, foldable/extendible arm that is fixedly attached to the vehicular body 11, in this example inside the housing 12. The milking head 92 comprises teat cups 94; in this example the milking head 92 is a cow milking head and there are four teat cups 94.

The milking head 92 also comprises teat brush construction 98 which includes 96 for cleaning the teats prior to milking. The teat brushes 96 are mounted on an extension 97 of the milking head 92 hingedly attached to the rest of the milking head at a pivot joint. The extension 97 is configured to be pivotable, under actuation by a suitable device, in this example a step motor, to pivot the teat brushes 96 horizontally towards the teat cups. In this manner, the teat brush construction 98 has at least two configurations including a stowed configuration, wherein the teat brushes 96 are placed, on the extension 97, away from the teat cups 94, and a working configuration, wherein the teat brushes 96 are placed, on the extension 97, towards the teat cups 94 in position to contact and brush the teats of an animal to be processed. In the example provided here, in the stowed configuration the teat brushes 96, on the extension 97, are placed away from teat cups 94 in the in the longitudinal direction of the milking head 92, which in this example is also the longitudinal direction of an animal positioned to be processed by the milking head. More particularly the brushes 96 pivot on extension 97 away from the teat cups 94 in the plane containing the longitudinal axis of the milking head and the vertical (e.g. bottom to top, or floor to ceiling) axis. In the example provided here, the teat brush construction 98 is provided at the longitudinal front of the milking head 92, that is away from the point of attachment of the milking head with the vehicular body 11, here towards the head of an animal in position to be processed. In this example, in the working configuration the teat brushes 96 are parallel to the longitudinal axis of the milking head, lying horizontally in front of the teat cups 94. The milking head 92 also has suitable hardware, in this example small electric motors, to cause the teat brushes 96 to rotate such that the teat brushes can be made to rotate when in the horizontal position so as to clean teats. This construction is particularly advantageous over prior constructions. Amongst other advantages, it allows for a longitudinally compact (narrow) construction which permits the milking head to be deployed between the hind legs of the domestic animal, which in turns allows a more compact and lightweight design for the animal processing device 10. This construction also allows for efficient stowing and cleaning of the milking head 92.

The milking head also comprises an electronic eye device (not shown) for determining the position of the individual teats for coordinating the brushing of the teats and the affixing of the teat cups 94.

In this example, the milking head 92, is a deployable milking head mounted on the mechanical arm assembly 102 which serves to extend the milking head 92 to a position where milking occurs and to return the milking head 92 to a stowed position. Thus the mechanical arm assembly 102 has at least one working configuration wherein the milking head 92 is extended away from the vehicular body 11 to a position for milking a domestic animal and a stowed configuration wherein the milking head 92 is retracted to a position towards the vehicular body 11, which can be a position close to or adjacent the vehicular body 11 but in this example is a position inside the housing 12 of the vehicular body 11. When activated by the controller unit, the mechanical arm assembly 102 unfolds and extends the milking head 92 out of the housing 12, between the legs of the cow that is in position to be processed/milked in this example in a standing position with its hind legs supported on the extended bridge 18. The milking head 92 can then automatically brush the teats with the teat brushes 96 and connect the teat cups 94 to the teats of the utter of the cow, milk the cow and sterilize itself. The fine movements of connecting the teat cups 94 to the teats are done with the help of the electronic eye device which provides feedback as to the location of the teats. This can be handed over to an independent milking head controller in the milking head 92 but in this example is also controlled by the controller unit.

The mechanical arm assembly 102 is operative to extend the milking head between the hind legs of a domestic animal towards the teats of the animal to milk it. In this example, the mechanical arm assembly 102 is a multi-hinge assembly comprising a shoulder joint 104 connecting a first link 106 to the vehicular body in a compartment 108 in the housing 12. The shoulder joint 104 is mechanically actuated, e.g. by an electric motor, to swing the first link 106 forward. An elbow link 110 links the first link 106 to a second link 112. The elbow link 110 is hingedly joined to the first link 102 at a first pivoting connection, and to the second link 112 at a second pivoting connection. The first and second pivoting connections are mechanically movable, e.g. by respective electric motors. As with the joints of the automatically displaceable arms 54, 54′, the actuators of the mechanical arm assembly 102 may be independently controllable by electric means by the controller. The milking head 92 is connected to the mechanical arm assembly 102 via a wrist joint 114 which links it to the second link 112. The wrist joint 114 has a pivoting connection with the second link 112 and another pivoting connection with the milking head 92 and enables pivoting of the milking head in two axes. Here too the pivoting connections are mechanically movable, e.g. by respective electric motors and in this example are independently controllable. The first axis of pivot stems from the pivoting connection with the second link 112 and is transverse to the longitudinal direction of the second link 112, and generally to the longitudinal direction of the mechanical arm assembly 102 itself when it is in the working configuration. This allows the movement of the milking head in a generally up-and-down manner, when the mechanical arm is in the working configuration, which can be used for moving the teat cups towards and away from the teats of an animal. The pivoting connection of the wrist joint 114 with the milking head 92 allows pivoting of the milking head about an axis that is generally vertical when the mechanical arm 102 is in the working configuration (as shown in FIG. 4). When the mechanical arm 102 is in the stowed configuration (as shown in FIG. 7), this axis becomes generally horizontal, extending generally in the longitudinal direction of the working-configuration mechanical arm. Thus the milking head 92 can be pivoted about two axes which are both generally transverse to longitudinal axis of the mechanical arm assembly 102 when in the working configuration, or at least are together in a plane that is transverse to the mechanical arm assembly 102 in the working configuration. This allows fine movement of the milking head 92 in a generally side-to-side direction in order to line the teat cups 94 up with the teats of the animal to milk.

Conduits mounted to the housing 12 will deliver the milk to a milk distribution pipeline, via at least one dedicated hose. The quality of the milk can also be tested automatically in the animal processing device 10 by the controller unit and, if of acceptable quality, then fed to the distribution pipeline. The quantity of milk being delivered by a cow can be monitored and automatically input to the controller unit with an identification of the respective cow. Once the milking robot has completed its milking operation, the milking robot disengages from the teats of the cow, sterilizes itself and the motorized arm supporting the milking robot retracts and refolds to withdraw the milking robot back inside of the housing 12.

In the present example, the vehicular body 11 comprises a cleaning compartment for cleaning the milking head 92. In this particular embodiment, the compartment 108 is the cleaning compartment and defines a chamber that is dimensioned, as shown in FIG. 7, to receive the milking head when in the stowed configuration. In this example, the chamber is dimensioned to receive the milking head and the mechanical arm assembly 102 upon which it is supported.

During milking operations, the milking head travels low to the ground in the animal's environment, which may be an unclean environment with animal excrements, food, straw and dirt which may come into contact with the cleaning head. Moreover, the cleaning head and the mechanical arm assembly 102 may come into contact with ejecta (e.g. excrement) from the animal during the milking operation. Since the teat cups are the entry point of milk, any impurities penetrating the teat cups may cause contamination of the harvested milk. Impurities may penetrate through the teat-receiving opening of the teat cups but may also enter through air inlets. Teat cups typically have an air inlet that forms a fluid passage from the milk line directly to the exterior of the teat cup. Air from the outside is sucked in through this inlet directly into the milk passage providing another route through which contaminants may come into contact with the harvested milk. Cows themselves may carry diseases that can be passed to other cows through common contact with the teat cups. One solution is to flush the teat cup interiors with a cleaning fluid after each milking operation but this does not perfectly clean the entire head.

The animal processing device of the present example comprises a cleaning system that provides a thorough cleaning of all sensitive parts of the device. In particular the cleaning system comprises the cleaning compartment 108 which allows a cleaning operation to be performed on the milking head 92 inside a chamber and thus in relative isolation of the external environment. The cleaning system also comprises a cleaning fluid delivery system for delivering cleaning fluid to the milking head assembly, which includes the milking head 92 and may include the mechanical support arm 102, as is the case here, for performing the cleaning operation. Advantageously, this permits a more thorough cleaning of the milking head 92. By performing a cleaning operation inside a chamber, nozzles may be provided around the chamber portions of the milking head 92 and mechanical arm assembly 102 that would otherwise be unreachable by fixed sprayers or that would be unreachable without spraying cleaning fluid beyond the intended part to clean into the stall/barn/animal's environment and perhaps on the animal itself. By performing the cleaning operation inside a chamber the spread of cleaning fluids are contained within the chamber, and drainage may be controlled, which not only can allow for more complete coverage of the cleaning head 92 and/or mechanical arm assembly 102 but also makes possible the use of harsher cleaning agents (soaps, disinfectants, degreases, anti bacterial agents, acids, bases, etc. . . . ) that would not be safe for use near animals and/or that cannot safely be allowed to spray onto the animal's environment, e.g. stall.

The cleaning compartment 108 may comprise a shuttable shield, which in this example may be an automatic door (not shown) which is actuated by a controllable actuator such as a step motor such that the door can be opened automatically by the controller to allow the milking head 92 to be deployed into the working configuration and closed when the milking head 92 is stowed within the chamber to isolate cleaning operations from the environment outside the chamber.

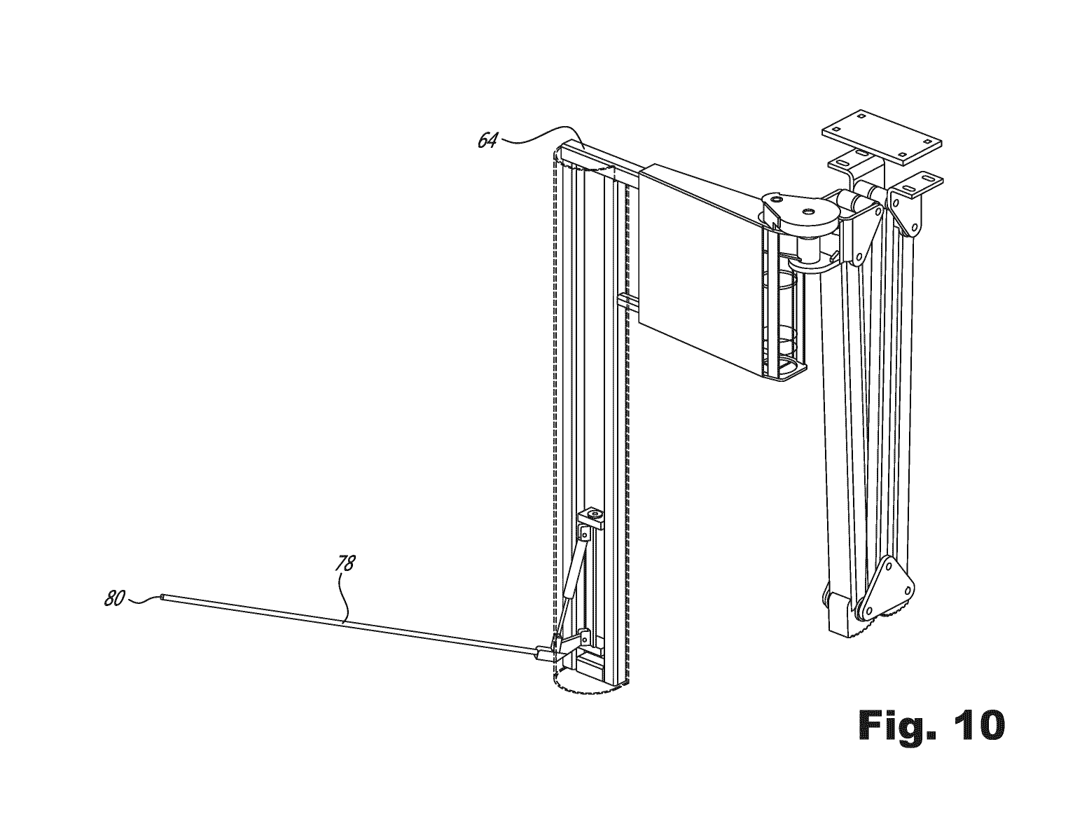

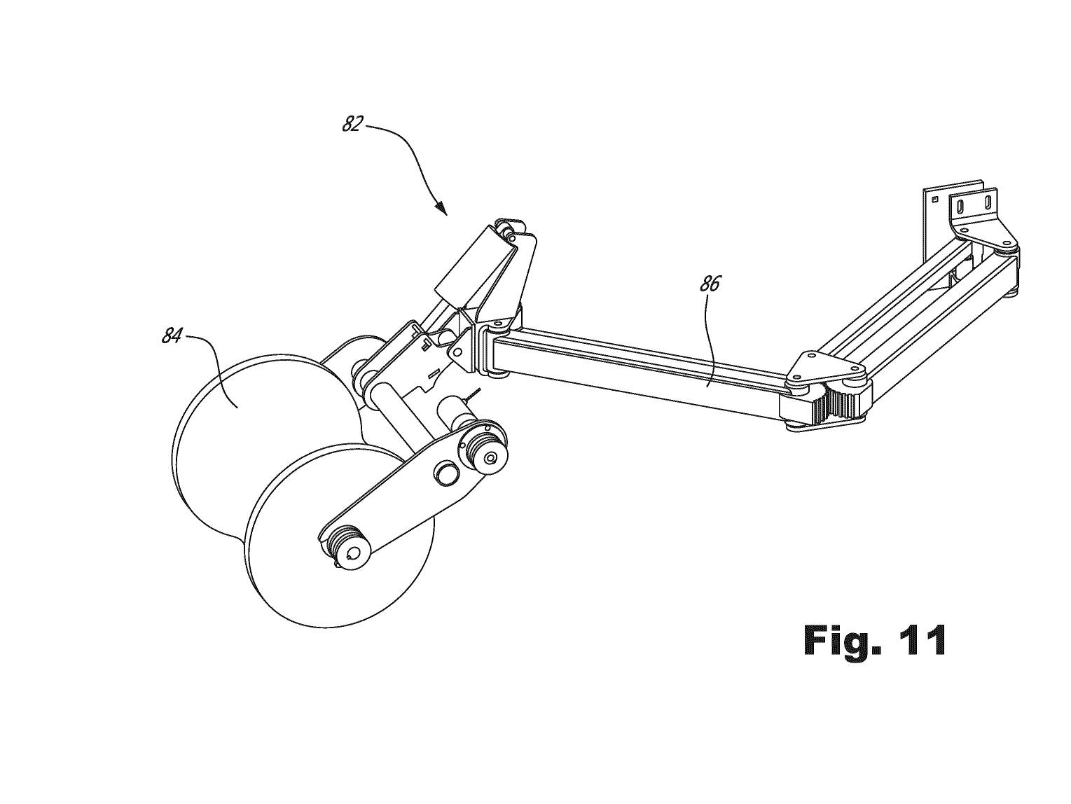

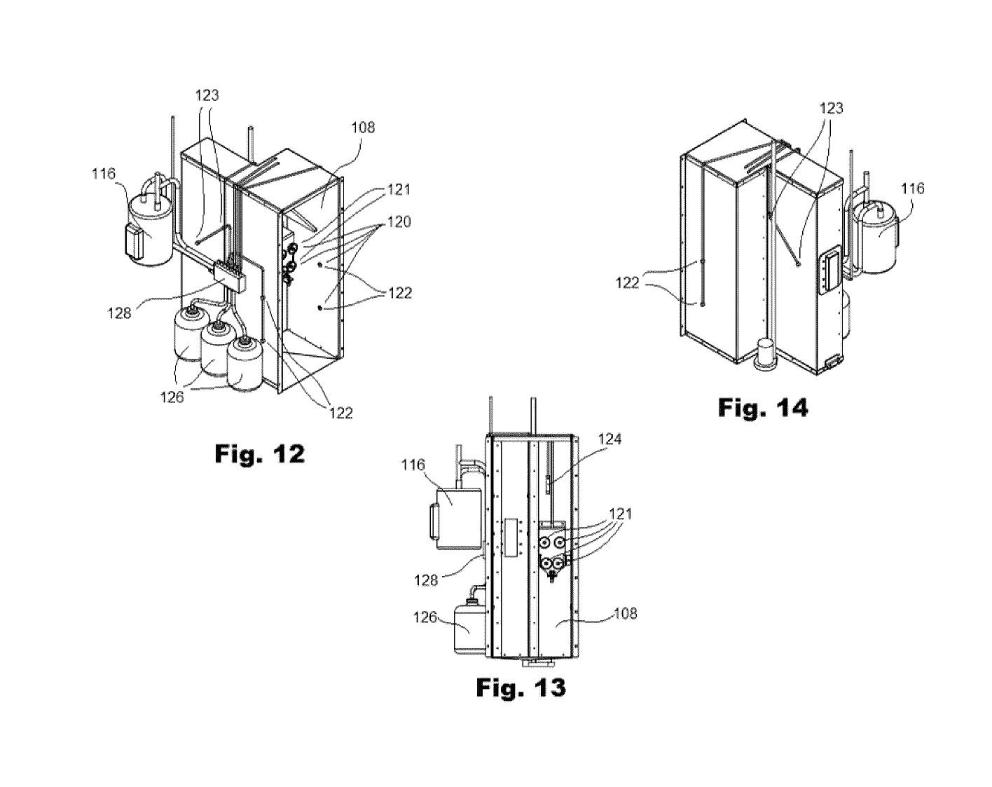

FIG. 12, FIG. 13 and FIG. 14 show the cleaning system. The milking head 92 and mechanical arm assembly 102 has been omitted in these figures to better show the interior of the cleaning compartment 108. The cleaning fluid delivery system comprises a cleaning fluid reservoir 116 which stores a cleaning fluid, which in this example is a liquid, more specifically water. In this example the cleaning fluid reservoir 116 is a hot water tank and includes a heating system for heating the water in the tank. The hot water tank of this example has an inlet pipe for filling the reservoir which connects to a flexible hose connection to a water supply. The flexible hose is provided in a manner allowing the vehicular body to move travel between stalls, in this case it provided on the ceiling of a barn in which the device is used. Although the cleaning fluid reservoir 116 is shown as being on provided on the vehicular body 11, it is envisaged that the cleaning system could be provided cleaning fluid from an external reservoir or source via a suitable inlet, e.g. fed by a flexible hose provided on the ceiling of the device's working environment.

In particular, the cleaning fluid is distributed to the milking head 92 and/or the mechanical arm assembly 102 via a set of nozzles 120. The nozzles 120 which in this context are any outlets, pressurizing or not, through which the cleaning fluid is provided onto the milking head assembly. In this particular example the nozzles are spraying nozzles that spray liquid cleaning fluid onto the milking head 92 and the mechanical arm assembly 102. The set of nozzles 120 are provided in the cleaning compartment 108 and pointed inwardly within the cleaning chamber for directing pressurized cleaning fluid towards the milking head 92 and the mechanical arm assembly 102. They are distributed on the walls of the cleaning chamber 108, and in particular they are provided on multiple walls of the cleaning chamber 108 so as to direct fluid onto multiple sides of the milking head 92 and/or mechanical arm assembly 102 so as to clean multiple sides thereof. This provides a particular advantage over prior solutions that only cleaned the teat cups and therefore only reached one side of the milking head. In those systems, grime could build up in unexposed parts of the milking head assembly that would lead to an unclean environment that fosters bacteria growth. By providing nozzles spraying the milking head assembly from multiple sides, greater cleaning coverage can be achieved to prevent such growth.

In the present example the cleaning fluid delivery system comprises at least one teat cup nozzle for delivering cleaning fluid to the teat cups. In this example, the cleaning fluid delivery system comprises a set of four teat cup nozzles 121 each positioned to be oriented towards the interior of a teat cup when the milking head 92 is in the stowed configuration. The teat cup nozzles are provided in respective teat cup holster receiving the teat cups lips. In addition to the teat cup nozzles, additional head nozzles 122 are located in the side walls of the cleaning compartment 108 and are oriented to direct cleaning fluid onto the body of the milking head, in this case onto the lateral sides of the body of the milking head. This provides a more comprehensive cleaning of the head than prior systems provided. Moreover still, the mechanical arm assembly 102 is also cleaned by the cleaning fluid delivery system, in particular by arm nozzles 123 which are positioned on the walls of the cleaning compartment 108 and oriented to direct cleaning fluid towards the mechanical arm assembly 102. Finally, a shower nozzle 124 is provided in the chamber to shower cleaning fluid over the whole or large parts of the milking head assembly. The shower nozzle could be provided on the ceiling of the cleaning chamber 108 but in this example is located high up on one of the walls. More than one shower nozzle could be provided.

In this manner, the cleaning system provides an isolated environment, akin to a dish washer, in which the mechanical head assembly can be thoroughly washed and disinfected. The exact configuration of the cleaning fluid delivery system, and in particular the location of the nozzles can be varied according to the construction of the device, an nozzles may be provided on the floor if desired and may be provided on moving parts such as on a spinning sprayer.

In the example shown here, the cleaning chamber 108 comprises an inclined bottom surface to gather fluids in the chamber towards a drain. In particular the cleaning chamber 108 has a floor that has multiple faces each inclined and meeting at junction lines that descend towards the drain. The drain may be connected to a drainage pipe. The drainage pipe may be lead to a waste water outlet, e.g. via a pump towards a flexible pipe provided on the ceiling or may in alternate example lead to an outlet over a drain trough as may be found in barns. For the latter example, which may be used when incorporating cleaning agents into the outlet of those troughs does not pose a problem, the drainage pipe may be provided with an incline for natural drainage towards the trough.

The cleaning fluid is received at a fluid distribution node 128, which distributes the fluid towards the nozzles. The fluid distribution node 128 is in fluid communication with the nozzles 120 via piping. In this example the fluid distribution node 128 comprises a simple dividing manifold that provides the output of the cleaning fluid reservoir to the piping, however in alternate embodiments a system of electronically controllable valves may be provided in the fluid distribution node 128 controlled by the controller to permit the controller to control which nozzles receive cleaning fluid at any moment in the cleaning process. Such valves may be provided elsewhere in the system, for example at the individual nozzles.

While the cleaning fluid may be or include water, in this example hot water, additional fluids may be used. In the illustrated example, three additives tanks 126 are provided for mixing with water to provide more thorough cleaning. In particular, the additive tanks may contain, for example, concentrated solutions of soaps, disinfectants, degreasers or other agents, for mixing with water to make a cleaning solution. The outlet of the additive reservoirs 128 are selectively combined with the outlet of the cleaning fluid reservoir 116 by a valve-controlled combining manifold that allows selective mixing of the additives with the cleaning fluid of the cleaning fluid reservoir 116 according individual valves for each reservoir that are electronically controlled by the controller. By providing additives to the water a different cleaning fluid is created that can be used for cleaning the milking head assembly. By controlling the output of the additives reservoirs, the controller may create a cleaning program whereby the milking head assembly is, e.g., first subjected to a degreasing solution, then a mild soap solution, then a disinfectant/antibacterial solution and finally rinsed thoroughly with hot water. Different programs may be created for different times, for example, the controller may cause a light cleaning with just soap and water between each milking but perform a more rigorous 3- or 4-step cleaning program using more aggressive cleaning agents at the end of a milking session (e.g. after all the cows have been milked).

Although cleaning agents are provided here in concentrated form to be mixed with water, in alternative embodiments cleaning solutions may be provided already prepared for application in their own tanks. The fluid distribution node may also be distributed. For example it may have two components, one at a dividing manifold for distributing cleaning fluid towards the nozzles and one at a combining manifold for selecting an additive and/or for selecting a tank output.

The controller, as programmatically implemented in software or as programmed into a hardware design such as an FPGA implements a cleaning method whereby the milking head is withdrawn into a stowed configuration whereby at least the milking head 92 but in this example also the mechanical arm assembly 102 is retracted into the cleaning compartment 108. If a shuttable shield is present, the controller causes the shutting of the shield to isolate the compartment interior from its exterior. The controller then causes a cleaning operation to occur inside the cleaning compartment 108 whereby the cleaning head, and in this case the mechanical arm assembly 102 is cleaned. In particular, in this example, the controller causes valves to open allowing passage of cleaning fluid through nozzles into the interior of the cleaning compartment 108 to clean the milking head 92 and in this example the mechanical arm assembly 102 as well. Optionally, the controller may also control an electrically controllable pump to control cleaning fluid pressure. In one particular example, the controller also causes the opening of valves to cause the addition of an additive into the cleaning fluid, once again optionally controlling a pump to regulate output pressure of the additive. Even more particularly, in one example the controller causes the addition of an additive into the cleaning fluid for a predetermined period of time to create a cleaning solution that is output through the nozzles onto the milking head assembly. Subsequently the controller causes the cessation of the addition of the additive, e.g. by closing a valve connecting the output of the additive's reservoir to the cleaning fluid's passage but continues to allow the cleaning fluid, e.g. hot water, to be output through the nozzles to rinse the cleaning solution from the milking assembly. Optionally, prior to or after rinsing the milking assembly, the controller may cause the addition of other additives from other reservoirs in the same manner described. Preferably, this is followed by a rinsing operation. Finally, after the completion of rinsing, the controller causes the cessation of output of cleaning fluid from the nozzles, e.g. by closing an electronically controlled valve controlling the output of the cleaning fluid reservoir. The milking assembly may then be kept stowed, which advantageously keeps it protected from external dust and dirt, or if further milking is required, the controller may cause the vehicular body 11 to be displaced to the next stall (optionally, this could be done while the cleaning operation is undergone, or beforehand), causes the opening of the shuttable shield if present, and causes the milking head to acquire the working configuration. In the present example before moving the milking head, the controller controls the automatically displaceable arms 54, 54′ to cause them to constrain an animal in the stall and to acquire their working configuration.

Various different types and designs of robotic milking machines can be used with the animal processing device 10, as well as different specialized machinery performing different operations on the animals processed by the animal processing device 10.

Note that the animal processing device 10 may include a pair of each specialized machinery for processing the animals, for example first and second robotic milking machines that are mounted inside the housing 12 such as to be accessible (i.e. extractable and retractable) from first and second opposite sides, respectively, of the housing 12, both activatable and controllable by the controller unit. Thus, when the animal processing device 10 supports a pair of animal controlling mechanisms 16 that simultaneously process a pair of cows located in stalls opposite one another on either side of the track 30, such as shown in FIGS. 4 and 5, one such specialized machinery is available for each cow during its processing. As discussed above, each one of the pair of specialized machinery may provide redundancy for the other, usable as a backup in case the other malfunctions or breaks down, where this redundancy is enabled by the rotatability of the animal processing device 10 by its elevator mechanism.

Also note that the animal processing device 10 may include at least one cleaning mechanism (independent from the cleaning system of the device 10) for each specialized machinery mounted thereon and performing operations on the animals. Each additional cleaning mechanism may be integral with the respective specialized machinery (e.g. sterilization system of milking robot) or, alternatively, may be implemented separately from the respective specialized machinery.

In a specific, non-limiting example, the automatic animal processing device 10 includes a pair of 12 Volt batteries that provide backup to ensure continued operation of the animal processing device 10 in the case of minute current reductions or unexpected power outages. These batteries are mounted inside the housing 12 and can be used to draw power to allow the animal processing device 10 to either finish processing that is underway or to terminate the processing and safely close up the machine. Advantageously, with the battery backup, the animal processing device 10 can automatically restart its operation when the current increases or the power returns.

In summary, the method of operation of the automatic animal processing device 10 of the present example comprises displacing the animal processing device 10 on a single track 30 to a predetermined location adjacent a rear end of a stall containing a domestic animal. The displaceable bridge 18 is actuated to extend a predetermined distance behind the stall over the gutter area 40, coming to rest on the edge of the stall, at which point the animal can be backed-up such that its hind legs are positioned on the bridge 18. The animal controlling mechanism 16 is then actuated, such that the body contacting cylinder bumpers 68 are positioned on either side of the body of the animal and move up the body of the animal until they reach the neck area of the cow, at which point they may be rotated inwardly to contact the body of the cow, if necessary. The animal controlling mechanism 16 is then retracted towards the housing 12, causing the animal to slowly back up until its hind legs are on the bridge 18 and spread apart, at which point processing can be effected by the animal processing device 10 on the animal, such as the milking operation, while the cow is retained by the body contacting cylinder rolls 68 of the animal controlling mechanism 16. Once the processing has been completed, the animal controlling mechanism 16 retracts back towards the housing 12, the body contacting cylinder bumpers 68 sliding off of the cow and releasing the cow such that it can return fully inside its stall. The housing 12 closes up, all machinery being retracted back inside of the housing 12 and all doors/panels acquiring the closed position, at which point a cleaning system of the animal processing device 10 is activated to clean both the interior and exterior of the animal processing device 10.

As mentioned above, the controller unit of the animal processing device 10 may communicate (e.g. over a wireless network) to a remote computing unit or device. During operation of the animal processing device 10, the controller unit is operative to collect data on the domestic animals being processed by the animal processing device 10, on the output or outcome of the process effected on the animals and on the status of the motors (e.g. how hard a motor is working) and of various other components of the animal processing device 10, including any malfunctions or problems, and may transmit all of the gathered data back to the remote computing unit for storage and/or processing by a control system. Appropriate sensors are provided on the animal processing device 10 to detect any malfunction of the apparatus or any problems with the animals, and the controller unit monitors these sensors and may transmit alarm conditions back to the remote control system accordingly. In a specific, non-limiting example of implementation, an alarm condition detected by the controller unit may result in the termination of an operation by the animal processing device 10 until an operator verifies the malfunction and resets the controller unit.

As such, the remote control system may comprise complex interacting circuits and devices to form a programmable system, which interacts with sensors and detectors within the animal processing device 10 to detect various conditions, abnormalities and problems, and interfaces with the various components and machinery of the animal processing device 10 via the controller unit to automatically control the displacement and all processing of the animal processing device 10.

In a variant example, the animal processing device 10 also includes, for each animal controlling mechanism 16, a positioning plate or board mounted to and projecting downwardly from the top beam 56 of the beam structure 52, against which an animal will back up when retrieved by the animal controlling mechanism 16. One or more sensors or detectors on this positioning plate can provide positioning information to the controller unit, for monitoring the position of the animal before the animal processing device 10 processes the animal. Furthermore, a rotatable arm may be attached to the positioning plate, controllable by the controller unit via an actuating device (e.g. electric motor) for moving an animal's tail out of the way before the animal processing device 10 processes the animal. Moreover the positioning plate may serve the additional function of protecting the animal processing device 10, particularly its processing machinery (e.g. milking head) and the components mounted underneath the base 14 (e.g. the displaceable bridge 18), from animal droppings and may be shaped and positioned accordingly.

In the above-described examples of implementation, the animal controlling mechanism 16 positions the animal in such proximity to housing 12 as to warrant a bridge over the gutter 40 for the animal to step on. In these examples, the bridge 18 also provides stability to the animal processing device 10. However, in variant embodiments, the animal processing device 10 may not comprise the bridge 18 but may comprise other stability mechanisms such as extending legs or struts and/or the animal processing device may process the animal while it is standing on the ground of its stall, providing that it is positioned in and restrained to a suitable position for the processing of the animal. For example, if the processing machinery (e.g. a milking head) extends far enough and if, optionally, a positioning plate is provided sufficiently far towards the animal, the animal may be captured and backed up into a position in its stall where it is still standing on the floor by the animal controlling mechanism 16 and restrained thereby for processing.

Although in the primary example the animal processing device 10 comprised two sets of automatically displaceable arms (on respective frames) and two sets of processing equipment (and two optional bridges) for simultaneously processing two animals, it will be understood that the device could be used for using the two sets in sequence or otherwise so as to process two animals using the two sets of arms and processing equipment non-simultaneously. It will also be understood that the animal processing device 10 may be provided only one set of automatically displaceable arms and one set of processing equipment and optionally one bridge for processing only a single domestic animal at a time. The ability for the animal device to pivot still allows it to process animals in stalls on both sides of an aisle in a tie-stall barn.

In yet another alternate example, the animal processing device can be provided only a single automatically displaceable arm 54. In this example, the animal processing device may employ existing stall infrastructure to help constrain the animal. In one particular example, an animal processing device has a single automatically displaceable arm of similar construction to that of the illustrated embodiment. When the animal processing device is displaced to the rear opening of a stall, the automatically displaceable arm is deployed to the working configuration alongside the domestic animal to be processed in order to immobilize it against a barrier or side wall of the stall. To reduce the gap, particularly for animals with lateral mobility, the vehicular body may move towards the barrier or side wall to reduce the area between the automatically displaceable arm and the barrier or side wall so as to constrain the animal. In one example, the animal is vehicular body is moved until a certain pressure is applied to the side of the animal by the automatically displaceable arm and stops. It then continues to move in the same direction whenever the pressure is release, i.e. by the animal moving away from the arm, until the animal no longer moves away from the arm. Alternatively the vehicular body may simply move by a predetermined distance. In another embodiment instead of moving the vehicular body, the automatically displaceable arm itself is moveable I the lateral direction, either on a rail or by pivoting towards the animal at the shoulder.

Although various embodiments have been illustrated, this was for the purpose of describing, but not limiting, the present invention. Various possible modifications and different configurations will become apparent to those skilled in the art and are within the scope of the present invention, which is defined more particularly by the attached claims.

1. An animal milking machine for automatically milking a domestic animal that is in a stall, said animal milking machine comprising:
a) a vehicular body displaceable in a stall environment to the rear opening of the stall, the vehicular body having a base;
b) at least one articulated arm connected to the vehicular body comprising a first link member and a second link member meeting together at an articulation, each of the at least one articulated arm having
i) a stowed configuration, wherein the articulation is closed and the first and second link members are tucked together towards the vehicular body to allow unimpeded displacement of the vehicular body, and
ii) a working configuration wherein the articulation is partially open such that the first and second link members form a V shape for flanking a captive domestic animal and immobilizing at least a rear portion the domestic animal in the lateral direction;
c) a mechanical arm assembly for supporting a teat cup connected to the vehicular body and automatically displaceable to connect the teat cup to a teat of the domestic animal when immobilized to milk the domestic animal.

2. The animal milking machine of claim 1, wherein the articulation is an elbow joint, the articulated arm being connected at a proximal end to the vehicular body at a shoulder joint.

3. The animal milking machine of claim 2, wherein the elbow joint is articulable to allow movement of the articulated arm in a vertical direction.

4. The animal milking machine of claim 3, wherein the elbow joint and the shoulder joint each comprise a respective actuator controllable to cause the respective joint to open and close, the actuators of the elbow joint and the shoulder joint being independently controllable to allow adjustment of the position of a distal end of the articulated arm in a vertical and a horizontal direction.

5. The animal processing device of claim 1, wherein the at least one articulate arms each comprise at least one monitoring sensor operative to detect the presence of the animal and for detecting of a size of the animal and automatically adjust to the size of the animal.

6. The animal milking machine of claim 1, wherein the at least one articulated arm comprises a set of two articulated arms spaced apart to extend on respective left and right sides of an animal to be milked.

7. The animal milking machine of claim 6, wherein the animal milking machine is a dual animal milking machine for simultaneously milking two animals in two stalls, wherein the vehicular body is displaceable to the rear opening of the two stalls, and wherein the at least one articulated arms comprises two sets of two articulated arms spaced apart to face the rear openings of respective ones of the two stalls for servicing respective ones of the two animals.

8. The animal processing device of claim 7, wherein the first and second sets of automatically displaceable arms are on opposed sides of the vehicular body for servicing respective domestic animals in stalls opposite one another.

9. The animal processing device of claim 1, wherein each of the at least one articulated arm comprises a body-engaging portion mounted on a displaceable support pivotably connected at a distal end of the automatically displaceable arm, wherein in the working configuration the neck-engaging portion engages with the neck area of the domestic animal to immobilize the domestic animal in the stall.

10. The animal processing device of claim 9, wherein the articulated arms are displaceable to automatically position the domestic animal to a position for processing by pulling it back with the neck-engaging portion so as to cause the domestic animal to back up.

11. The animal processing device of claim 1, further comprising a controller unit for controlling operation of the animal processing device including at least a automatic displacement of the at least one articulate arm and the displacement of the vehicular body.

12. (canceled)

13. The animal processing device of claim 1, wherein the animal processing device comprises a power backup operative to control an operation of the animal processing device when power to the animal processing device is reduced or cut.

14. The animal processing device of claim 1, wherein the vehicular body further comprises a frame supporting the at least one articulated arms, wherein the frame comprises a horizontal cross-member to which is connect the at least one articulated arm at an adjustment connection that can be adjusted to modify its position on the horizontal cross-member.

15. (canceled)

16. (canceled)

17. (canceled)

18. (canceled)

19. The animal processing device of claim 1, wherein the vehicular body comprises a locomotion mechanism comprising a motorized propulsion system for displacing the vehicular body to the rear opening of the stall.

20. (canceled)

21. An animal milking machine for automatically processing a domestic animal in a stall, said animal milking machine comprising:
a) a vehicular body displaceable to approach the domestic animal to perform a milking operation on the domestic animal;
b) a mechanical arm assembly for supporting a teat cup connected to the vehicular body and automatically displaceable between a working configuration wherein the mechanical arm assembly is extended away from the vehicular body to connect the teat cup to a teat of the domestic animal to milk the domestic animal and a stowed configuration wherein the mechanical arm assembly is retracted toward the vehicular body;
c) a cleaning compartment in the vehicular body defining a chamber dimensioned to receive the mechanical arm assembly when in the stowed configuration and a cleaning fluid delivery system for performing a cleaning operation upon the mechanical arm assembly in the chamber in the vehicular body.

22. The animal milking machine of claim 21, wherein the cleaning compartment comprises a shuttable shield for enclosing the mechanical arm assembly within the chamber to isolate the cleaning operation from the exterior of the chamber.

23. The animal milking machine of claim 21, wherein the cleaning fluid delivery system comprises a plurality of nozzles pointed inwardly within the chamber for directing a pressurized cleaning fluid towards the mechanical arm assembly during the cleaning operation.

24. The animal milking machine of claim 23, wherein the plurality of nozzles are disposed on at least two different sides of the chamber for cleaning multiple sides of the mechanical arm assembly.

25. The animal milking machine of claim 24, wherein the mechanical arm assembly comprises a milking head having a body supporting the teat cup, and wherein the cleaning fluid delivery system comprises teat cup nozzles directed towards the opening of the teat cup when in the stowed configuration, the cleaning fluid delivery system comprising at least one additional nozzle directed towards the body of the milking head.

26. (canceled)

27. The animal milking machine of claim 1, wherein the cleaning fluid delivery system comprises at least one cleaning fluid tank in fluid communication with a fluid distribution node, the fluid distribution node being in fluid communication with the plurality of nozzles for distributing cleaning fluid from the at least one fluid tank to the plurality of nozzles.

28. The animal milking machine of claim 27, wherein the at least one cleaning fluid tank comprises a hot water tank and at least one additive tank each being in fluid communication with the fluid distribution node, the fluid distribution node being configured to distribute a mixture of hot water and additive to the plurality of nozzles.

29. (canceled)

30. A dual animal milking machine for automatically milking two domestic animals in respective stalls, the dual animal milking device comprising:
a) a pair of animal operation equipment each comprising:
i) an animal controlling mechanisms for immobilizing a respective one of the two domestic animals to perform a milking operation;
ii) a mechanical arm assembly for supporting a teat cup deployabe to connect the teat cup to a teat of a respective one of the two domestic animals when immobilized by the animal controlling mechanism to milk the respective one of the two domestic animals;
b) a vehicular body displaceable in a stall environment to simultaneously align the pair of animal operation equipment with respective rear openings of respective stalls;
c) a controller in communication with the pair of animal controlling mechanisms and the pair of mechanical arm assemblies for controlling the operations thereof;
wherein the dual animal milking machine has two operational modes:
a full operation mode, whereby each of the animal operation equipments function simultaneously to perform simultaneous milking operations; and
a half operation mode, whereby one of the animal operation equipments services each of the two domestic animals to perform a milking operation on each of them in sequence.

31. The dual animal milking machine of claim 30, further comprising a transfer mechanism under control of the controller for transferring the vehicular body during half operation mode to align one of the pair of animal operation equipments sequentially with each of the respective stalls to perform sequential milking operations on both of the two domestic animals in sequence using the same animal operation equipment.

32. The dual animal milking machine of claim 31, wherein the pair of animal operation equipment are disposed on opposite sides of the vehicular body for operation animals in stalls opposite one another, and wherein the transfer mechanism comprises a pivoting mechanism for pivoting the vehicular body to reverse the sides of the two animal operation equipments in the pair of animal operation equipment.

33. The dual animal milking machine of claim 32, wherein the transfer mechanism comprises a scissor lift for lifting the vehicular body to rotate it.

34. The dual animal milking machine of any of claim 33, configured to detect a defect in one of the pair of animal operation equipment and to enter half operation mode on the basis of the detection of a defect in one of the pair of animal operation equipment.

35. The dual animal milking machine of claim 34, wherein the controller is configured to determine whether each of the animal operation equipment are functioning properly and, upon a determination that one of animal operation equipment in the pair is not functioning properly to engage half operation mode using the other operation equipment.
